(19) United States
(12) Patent Application Publication
(10) Pub. No.: US 2012/0254935 A1
(43) Pub. Date: Oct. 4, 2012

(54) AUTHENTICATION COLLABORATION SYSTEM AND AUTHENTICATION COLLABORATION METHOD

(75) Inventors: Akifumi YATO, Sagamihara (JP); Tadashi KAJI, Yokohama (JP); Naoki HAYASHI, Yokohama (JP); Shinichi IRUBE, Yokohama (JP)

(73) Assignee: HITACHI, LTD., Tokyo (JP)

(21) Appl. No.: 13/358,600

(22) Filed: Jan. 26, 2012

(30) Foreign Application Priority Data
Mar. 30, 2011 (JP) 2011-076270

(51) Int. Cl. G06F 21/00

(52) U.S. Cl. 726/1

(57) ABSTRACT

An authentication collaboration server of an authentication collaboration system performs a secrecy calculation process using authentication information as input for an authentication process, generating secret authentication information for each piece of the authentication information. An authentication information verification server obtains and compares sets of the combination of secret authentication information generated by the authentication server, and a user ID identifying a user of a user terminal using the authentication information that is a source of the secret authentication information. The authentication information verification server extracts the plurality of pieces of authentication information that have been applied. The authentication collaboration server approves a service, when a user authentication state is removed as authentication results constituting the user authentication state satisfies the policy for the service, after an authentication result in which application of the authentication information has occurred. A collaboration service is achieved including multiple low cost Web services.

### INCORPORATION BY REFERENCE

The present application claims priority from Japanese application serial No. 2011-076270, filed on Mar. 30, 2011, the entire contents of which are hereby incorporated by reference into this application.

### FIELD OF THE INVENTION

The present invention relates to a technology for authentication collaboration system and authentication collaboration method.

### BACKGROUND OF THE INVENTION

Recently, in Internet services and various intranet systems, the number of services for each person for which his or her IDs/passwords are registered has increased year by year. The management of a large number of IDs/passwords is a heavy burden on the user. It is difficult to set different passwords to different services and to remember them all.

For example, JP-A No. 113462/2010 discloses single sing-on that allows the user to access to a plurality of services requiring user authentication by performing user authentication only once. With the approach, it is possible to reduce the number of passwords managed by the user, so that the user can manage passwords more securely.

“Profiles for the OASIS Security Assertion Markup Language (SAML) V2.0.”, OASIS Standard, March 2005 relates to a single sign-on technology called Security Assertion Markup Language (SAML), which is developed as a markup language specification by the OASIS standards body to describe a method for securely transmitting security data, such as authentication results and access approval determination results, by the Extensible Markup Language (XML). In the SAML, a so-called identity provider (IdP) issues the result of user authentication as a message called an assertion, and provides to a service called a service provider (SP). Then, the SP relies on the assertion to detect whether the user is authenticated or not.

### SUMMARY OF THE INVENTION

In services requiring high security, such as on-line banking and official procedures, there may be a system configuration (multi-factor authentication) that uses some combination of a plurality of user authentication results to receive one service. In this configuration, even if one user authentication factor of the multi-factor authentication is successful by a malicious attacker, the service is not allowed as long as the other user authentication factor of the multi-factor authentication is successful. Thus, the security of the system can be increased.

However, for example, some users may use (apply) the same password in multi-factor authentication, neglecting the need to manage passwords as independent factors for multi-factor authentication. At this time, once one user authentication is broken by an attacker, the other user authentication is sequentially broken. As a result, sufficient security will not be guaranteed even if multi-factor authentication is used.

Accordingly, a principal object of the present invention is to solve the above problem, and provide a system using a combination of a plurality of authentication results while preventing the reduction in the security.

In order to solve the above problem, an aspect of the present invention is an authentication collaboration system for approving execution of a service provided by an application server to a user terminal used by a user, by requiring results of authentication performed multiple times for the user as a user authentication state, according to the policy for the approval of the service. In the authentication collaboration system, an authentication server outputs the authentication results constituting the user authentication state by determining that the authentication process is successful when authentication information corresponding to the user is data registered in a storage unit of the own device. Further, an authentication collaboration server approves the service when the user authentication state, which is a set of the authentication results output from the authentication server, satisfies the policy specified for each service. Further, an authentication information verification server verifies application in a plurality of pieces of the authentication information, with respect to the particular authentication information used for the authentication process by the authentication server. In this configuration, the authentication server performs a secret calculation process using, as input, the authentication information used for the authentication process, to generate secret authentication information for each piece of the authentication information. Then, the authentication information verification server obtains and compares a plurality of sets of the combination of the secret authentication information generated by the authentication server, as well as a user ID uniquely identifying the user of the user terminal using the authentication information that is the source of the secret authentication information. Then, the authentication information verification server extracts the plurality of pieces of authentication information that are applied in relation to the particular combination. Then, the authentication collaboration server determines whether the user authentication state after the authentication result in which application of the authentication information has occurred is removed as the authentication results constituting the user authentication state, satisfies the policy in the process for approving the service.

Other components will be described below.

According to the present invention, it is possible to prevent the reduction in the security when a plurality of user authentication results are combined and used together.

### BRIEF DESCRIPTION OF THE DRAWINGS

FIG. 1 is a block diagram of an authentication collaboration system according to a first embodiment of the present invention;

FIG. 2 is a detailed block diagram of the components of the authentication collaboration system according to the first embodiment of the present invention;

FIG. 3 is a hardware block diagram of each computer of the authentication collaboration system according to the first embodiment of the present invention;

FIG. 4 is a flowchart of a process for using the service content of a first service ID by a user ID “taro”, according to the first embodiment of the present invention;

FIG. 5 is a flowchart of a process for using the service content of a second service ID by the user ID “taro” after executing FIG. 4, according to the first embodiment of the present invention;

FIG. 6 is a flowchart of the operation of an authentication collaboration server in the process of FIGS. 4 and 5 according to the first embodiment of the present invention;

FIG. 7 is a flowchart of the operation of an authentication information verification server in the process of FIGS. 4 and 5 according to the first embodiment of the present invention;

FIG. 8 is a block diagram of an authentication collaboration system according to a second embodiment of the present invention;

FIG. 9 is a detailed block diagram of the components of the authentication collaboration system according to the second embodiment of the present invention;

FIG. 10 is a flowchart of a process that is started on the side of domain A, according to the second embodiment of the present invention;

FIG. 11 is a flowchart of a process that is stared on the side of domain B by a service request to the domain B, according to the second embodiment of the present invention; and

FIG. 12 is a flowchart of the steps performed by an SAML SP unit according to the second embodiment of the present invention.

### DETAILED DESCRIPTION OF THE PREFERRED EMBODIMENTS

Hereinafter an embodiment of the present invention will be described in detail with reference to the accompanying drawings.

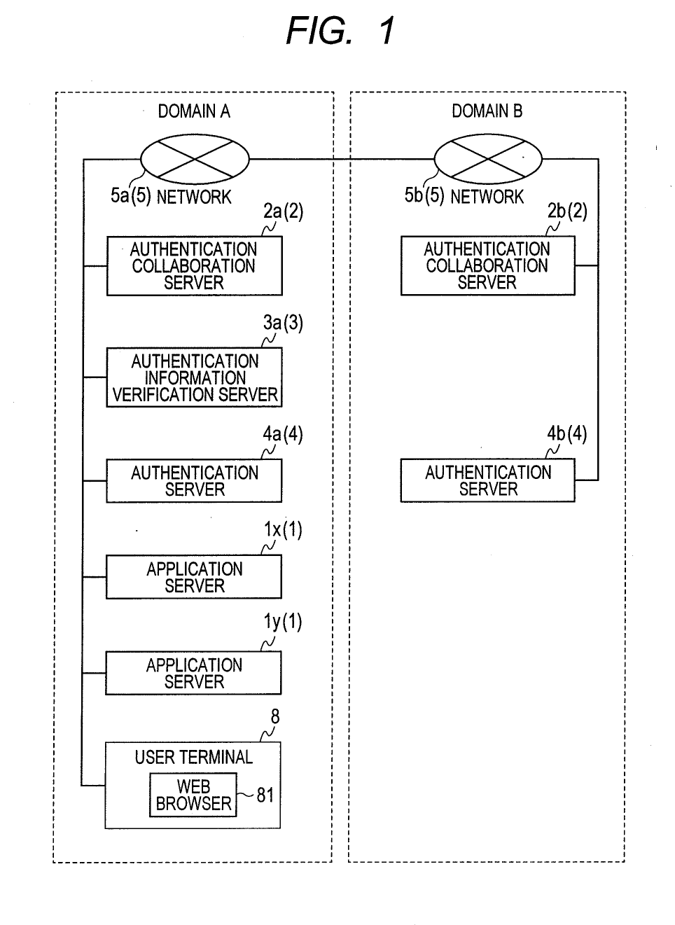

FIG. 1 is a block diagram of an authentication collaboration system. The authentication collaboration system includes two domains A and B, which are connected by networks 5a and 5b. The networks 5a, 5b may be private networks such as intranet local area network (LAN), or may be open networks such as the Internet.

Note that in the following description, when the same component is present in the two domains, the suffix “a” or “b” of the component represents the domain to which the particular component belongs. For example, an authentication collaboration server 2 includes an authentication collaboration server 2a in the domain A, and an authentication collaboration server 2b in the domain B.

The authentication collaboration system using SAML includes, as the configuration for authentication, the authentication collaboration servers 2a and 2b, an authentication information verification server 3, and authentication servers 4b and 4a.

Further, as devices using the authentication result, there are also provided a user terminal 8, an application server 1x, and an application server 1y. The user terminal 8 communicates with other devices of the authentication collaboration system. Thus, the user terminal 8 includes a Web browser 81 for performing the communication.

With respect to the configuration of the devices, each device can be physically placed in one package, or a plurality of devices, such as the authentication collaboration server 2, the authentication information verification server 3, can be physically placed in one package.

The terms used in this embodiment are defined as follows.

TABLE 1
Authentication check parameters

| | | Authentication | Authentication |
|---|---|---|---|
| | | server 4a | server 4b |
| | User | (First password | (Second password |
| Item | terminal 8 | authentication) | authentication) |
| User ID | User ID | First user ID | Second user ID |
| | taro | taroauth1 | taroauth2 |
| User ID for | Hash value | | |
| application | of the | | |
| detection | user ID | | |
| | qnls85o5mftw | | |
| Authentication | | First | Second |
| information | | authentication | authentication |
| | | information | information |
| | | taropw1 | taropw2 |
| Authentication | | First hash | Second hash |
| information | | value | value |
| hash value | | 50j89qbqmnnwjh3r | b4g0figxnyt7hb6 |
| | | 8a1gm90xoj1qp | qb916uuswr9e3cy |
| Secret | | First secret | Second secret |
| authentication | | authentication | authentication |
| information | | information | information |
| | | d7xlk9s9bciz2rkf | rc41iazpxls01ar3 |
| | | opt5u1zisz3vhiy | 2ugmnz6dtxav2p |

Table 1 shows the authentication check parameters. The table column elements represent the parameters for each user who operates the user terminal 8, the parameters for each authentication server 4a, and the parameters for each authentication server 4b.

The item “user ID” is the ID for identifying the user. There are not only the user ID “taro” for each user (user terminal 8), but also a first user ID “taroauth1” on the authentication server 4a used by the user ID “taro”, and a second user ID “taroauth2” on the authentication server 4b used by the same user ID “taro” are registered in “user ID”. Note that the alphanumeric characters (such as “taro”) in the second and subsequent lines in each cell value of the Table 1 are examples of the parameter name (user ID) shown in the first line of each cell value.

The item “user ID for application detection” is configured as the hash value of the user ID. The hash value is generated from the data (taro) that humans can read, making it difficult for attackers to sneak a look at the data while keeping the information that the hash value originally meant.

The item “authentication information” is the input information for authentication corresponding to the user ID for each authentication server 4.

When the authentication method is “password authentication”, the authentication information is “password (character string)”.

When the authentication method is “digital certificate authentication”, the authentication information is “digital certificate”.

When the authentication method is “biometrics authentication”, the authentication information is “information generated from the body of the user (based on the value measured by a biometric sensor).

The item “authentication information hash value” is similar to the item “user ID for application detection” that increases the difficulty in reading by hashing the authentication information. A first hash value is generated from first authentication information, and a second hash value is generated from second authentication information.

The item “secret authentication information” is the parameter generated by performing a secret calculation using the authentication information or the authentication information hash value as input data. The secret calculation is specified by the authentication method.

When the authentication method is “password authentication” or “digital certificate authentication”, the secret authentication information is the calculation result of “one-way function (hash function such as sha-1 or MD5)” as the secret calculation. Then, when the generated first secret authentication information matches the generated second secret authentication information, the same user uses the same data for a plurality of pieces of authentication information. Thus, the first authentication information and the second authentication information are detected as vulnerable authentication information.

When the authentication method is “biometrics authentication”, the secret authentication information is the calculation result of “invariant one-way transformation process of biometrics information correlation” as the secret calculation. Note that the one-way transformation process uses a private key (which is a character string generated from the private key of the authentication server 4 by adding the user ID) for application detection. Then, when the degree of similarity is equal to or greater than a predetermined value in the image processing of the generated first secret authentication information and the generated second secret authentication information, the same user uses the same data for a plurality of pieces of authentication information. Thus, the first authentication information and the second authentication information are detected as vulnerable authentication information.

As described above, the generated secret authentication information is included in the communication message, and is transmitted between devices. When privacy information, such as user ID and attribute information, is provided to other services, the user should be particularly careful so that the authentication information, such as the password used for user authentication, is not leaked to third parties.

When the authentication information hash value is managed on the authentication server, and even if the content is protected from being read by a third party, the third party transmits the authentication information of this state to the authentication server 4 to impersonate the owner of the authentication information, and finally, the user authentication is successful.

Thus, when the authentication information is provided to the outside, the secret authentication information shown in the Table 1 is provided, instead of the authentication information and the authentication information hash value. In this way, even if the secret authentication information is obtained by a third party, the authentication information managed by the authentication server 4 may not be obtained from the secret authentication information, preventing the third party from impersonating the owner of the authentication information.

TABLE 2
Authentication check items

| Item | Process content | Success example | Failure example |
|---|---|---|---|
| Approval | Approve execution of | The authentication | The authentication |
| | the service when the | state of the user | state of the user |
| | user authentication | “taro”, “first | “taro”, “first |
| | state satisfies the | password | password |
| | policy for the | authentication, | authentication” |
| | service. | second password | does not satisfy |
| | | authentication” | the service policy |
| | | satisfies the | “two-time password |
| | | service policy “two- | authentication”. |
| | | time password | |
| | | authentication”. | |
| Authentication | Authenticate whether | The first password | The first password |
| | the user is valid | authentication is | authentication |
| | based on the input | successful when the | failed when the |
| | authentication | input combination | input combination |
| | information for each | of <first user ID, | of <first user ID, |
| | authentication | first | second |
| | server. | authentication | authentication |
| | | information> is | information> is not |
| | | registered in the | registered in the |
| | | authentication | authentication |
| | | server 4a. | server 4a. |
| Application | Verify whether the | The combination of | The combination of |
| verification | same user applies | <user ID for | <user ID for |
| | the same data for a | application | application |
| | plurality of pieces | detection, first | detection, first |
| | of authentication | secret | secret |
| | information. | authentication | authentication |
| | | information> does | information> |
| | | not match <user ID | matches <user ID |
| | | for application | for application |
| | | detection, second | detection, second |
| | | secret | secret |
| | | authentication | authentication |
| | | information>. | information>. |
| Unit | Verify whether used | The same character | The same |
| verification | authentication | string as the first | character string as |
| | information is | user ID is not | the first user ID |
| | vulnerable to | included in the | is included in the |
| | outside attacks, | first | first |
| | when the | authentication | authentication |
| | authentication | information. | information. |
| | information is | The number of | The number of |
| | viewed as a unit. | characters of the | characters of the |
| | | first | first |
| | | authentication | authentication |
| | | information is more | information is |
| | | than 5. | equal to or less |
| | | | than 5. |

Table 2 shows four authentication check items (approval, authentication, application verification, and unit verification) based on each of the parameters defined in the Table 1.

“Authentication” shown in the second line of the Table 2 is the process for authenticating whether the user is valid or not based on the input authentication information for each authentication server 4. When the authentication is successful, an authentication assertion is issued.

“Approval” shown in the first line of the Table 2 approves the execution of the service when the user authentication state, which is indicated by the issued authentication assertion, satisfies the policy required for the service. With respect to the item “approval”, the policy may require a plurality of authentication assertions to receive one service, or may require sharing the necessary authentication assertion among services to receive the services.

“Unit verification” shown in the fourth line of the Table 2 is the process for verifying whether the authentication information is vulnerable to attacks from others, when the authentication information used for the “authentication” is viewed as a unit. In this case, the security can be increased when only the authentication assertion that has passed the “unit verification” is used for the “approval”.

“Application verification” shown in the third line of the Table 2 is the process for verifying whether the same data is applied for a plurality of pieces of authentication information by the same user that are used for the “authentication”. In this case, the security can be increased when only the authentication assertion that has passed the “application verification” is used for the “approval”.

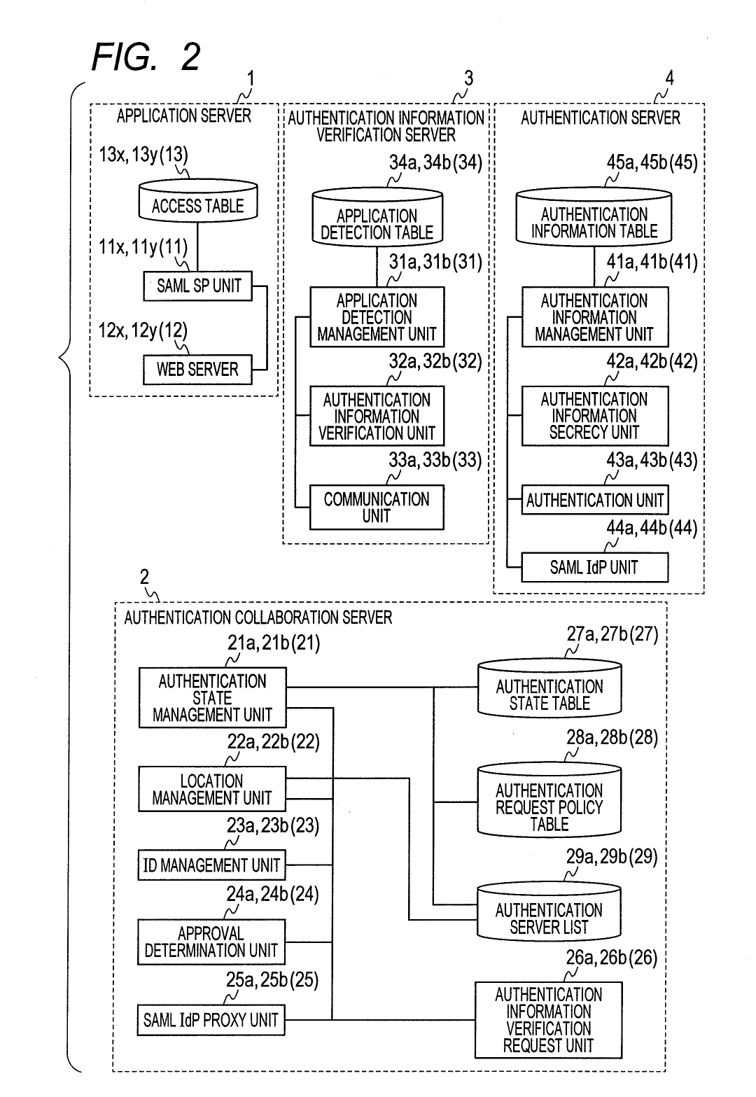

FIG. 2 is a detailed block diagram of the components constituting the authentication collaboration system. Note that in the following description, similar to that in FIG. 1, when the same component is present in the two domains, the suffix “a” or “b” of the component represents the domain to which the particular component belongs. For example, an authentication state management unit 21a is included in the authentication collaboration server 2a of the domain A, and an authentication state management unit 21b is included in the authentication collaboration server 2b of the domain B.

The application server 1 receives a process request from the user terminal 8. Then, when the authentication collaboration server 2 approves the request, the application server 1 provides the service content corresponding to the process request, to the user terminal 8. Note that FIG. 2 shows, as an example, two application servers 1x, 1y. In the following description of flowcharts and the like, the suffix “x” or “y” represents the application server 1x or 1y in which the particular component is present.

The application server 1 includes an SAML SP unit 11, a Web server 12, and an access table 13. The SAML SP unit 11 communicates with the user terminal 8, and provides access control based on the approval determination result. The Web server 12 executes the service based on the service execution parameters received from the user terminal 8, and presents the service content to the user terminal 8. The access table 13 stores the approval determination result that is used for access control.

The authentication collaboration server 2 exists in each network 5. Upon receiving the process request from the user terminal 8, the authentication collaboration server 2 determines based on the authentication result from the authentication server 4 whether the access to the application server 1 is approved with respect to the user terminal 8. The authentication collaboration server 2 selects and determines the authentication server 4, either the authentication server 4a or 4b, from which the authentication result is obtained. Then, the authentication collaboration server 2 asks for authentication to the user terminal 8.

Thus, the authentication collaboration server 2 includes an authentication state management unit 21, a location management unit 22, an ID management unit 23, an approval determination unit 24, an SAML IdP Proxy unit 25, an authentication information verification request unit 26, an authentication state table 27, an authentication request policy table 28, and an authentication server list 29.

The authentication state management unit 21 manages the authentication state of the user terminal 8 as well as the policy of the application server 1.

The location management unit 22 manages the URL of the authentication server 4 to collaborate with.

The ID management unit 23 manages the user ID used on the application server 1, together with the user ID used on each authentication server 1.

The approval determination unit 24 compares the authentication state of the user terminal 8 with the policy of the application server 1. Then, the approval determination unit 24 determines whether the access to the application server 1 is approved.

The SAML IdP Proxy unit 25 communicates with the user terminal 8, and requests a user authentication process to the other authentication collaboration server 2 and the authentication server 4.

The authentication information verification request unit 26 communicates with the authentication information verification server 3, and requests a determination of the vulnerability of the authentication information to the authentication information verification server 3.

The authentication state table 27 stores the authentication state of the user terminal 8.

The authentication request policy table 28 stores the policy of the application server 1.

The authentication server list 29 stores the URL of the authentication server 4 to collaborate with.

The authentication information verification server 3 exists in each domain. The authentication information verification server 3 verifies whether the authentication information used for the authentication by the user is vulnerable (application verification, unit verification in the Table 2), based on the secret authentication information obtained from the authentication collaboration server 2 as well as the authentication information property. Note that the authentication information property is a list of the features that the authentication information has. Examples of the features are the length of the password, and the type of characters (alphabets, numbers, symbols) used in the password.

Thus, the authentication information verification server 3 includes an application detection management unit 31, an authentication information verification unit 32, a communication unit 33, and an application detection table 34.

The application detection management unit 31 manages the secret authentication information that is determined to be invulnerable as a result of the vulnerability determination.

The authentication information verification unit 32 verifies whether the authentication information used for the authentication by the user is vulnerable or invulnerable, based on the secret authentication information obtained from the authentication collaboration server 2, the authentication property, and the secret authentication information stored in the application detection table 34 described below.

The communication unit 33 communicates with the authentication collaboration server 2.

The application detection table 34 stores the secret authentication information obtained from the authentication collaboration server 2.

The authentication server 4 exists in each domain. The authentication server 4 performs user authentication with the user terminal 8. Then, the authentication server provides the authentication result, the secret authentication information of the user who has been authenticated, and the authentication property to the authentication information verification server 3 through the authentication collaboration server 2.

Thus, the authentication server 4 includes an authentication information management unit 41, an authentication information secrecy unit 42, an authentication unit 43, an SAML IdP unit 44, and an authentication information table 45.

The authentication information management unit 41 manages the authentication information of the user.

The authentication information secrecy unit 42 generates the secret authentication information and authentication property from the authentication information of the user.

The authentication unit 43 performs user authentication by comparing the authentication information obtained from the user terminal 8, with the authentication information stored in the authentication information table 45 described below.

The SAML IdP unit 44 communicates with the user terminal 8, and transmits the authentication result to the authentication collaboration server 2 through the user terminal 8.

The authentication information table 45 stores the authentication information of the user.

Note that the matching process (application verification in the Table 2) of a plurality of pieces of secret authentication information is designed to detect application of the same authentication information, if a plurality of matching combinations of <user corresponding to authentication information, secret authentication information generated from authentication information> are present. However, as the matching target for application detection, in addition to the data of the above combination, other data of a combination of <information that can identify the user, information that can identify the authentication information of the user> can also be used.

For example, it is possible to generate a combination of <information that can identify the user, information that can identify the authentication information of the user> according to the following procedures 1 to 3.

Procedure 1: Set a temporary user ID, as the information that can identify the user, to the session ID shared by the user terminal 8 used by the particular user, and the authentication server 4. Note that the session ID is the ID necessary for managing parameters obtained by transmitting and receiving messages.

Procedure 2: Generate a character string by connecting the characters of the user identifiable information obtained in the procedure 1, and the characters of the authentication information by using a colon or other punctuation mark.

Procedure 3: Generate secret authentication information including the user identifiable information by performing a secrecy process by the authentication information secrecy unit 42 with respect to the character string generated in the procedure 2.

Note that in the procedure 1, the session ID generated by one authentication server 4 is used by the other authentication server 4, so that the session ID functions as an alternate data (temporary user ID) of the user ID that can identify the user. Thus, the user ID that has been generated before the user terminal 8 establishes a new session with one authentication server 4, by the authentication server 4 other than the destination of the new session, is included in the process request (Set-cookie header) from the user terminal 8 to the authentication server 4. In this way, it is possible to use the existing session ID also in the new session.

Then, the matching process between a plurality of pieces of secret authentication information is performed according to the following procedure 4.

Procedure 4: The authentication information verification unit 32 compares a plurality of pieces of the secret authentication information generated in the procedure 3. When matching secret authentication information is detected, the authentication information verification unit 32 determines that the authentication information is applied by the same user. However, even if one user and the other user use the same authentication information (such as password character string) by chance, the character string generated in the procedure 2 is different for each user. Thus, false detection of application between different users will not occur in the procedure 4.

In this way, it is possible to prevent abuse of the secret authentication information by an administrator of the authentication information verification server 3 in such a way that the administrator estimates the authentication information of the user by illegally using the same secret authentication information to impersonate the user.

TABLE 3

| | | |
|---|---|---|
| Service ID | Application server | Policy |

28 Authentication request policy table

| | | |
|---|---|---|
| 0-th service ID | (Application server 1) | One-time digital |
| 6l6ui59y3q7y | | certificate authentication |
| First service ID | Application server 1x | One-time password |
| 1ieir3n5376w | | authentication |
| Second service ID | Application server 1y | Two-time password |
| cpe7khm15cem | | authentication |

| | |
|---|---|
| User ID | User authentication state |

27 Authentication state table

| | |
|---|---|
| hanako | Digital certificate authentication, |
| | Biometrics authentication |
| taro | First password authentication |
| | Second password authentication |

| | | |
|---|---|---|
| | Authentication | Number of corresponding |
| Authentication server URL | method | services |

29 Authentication server list

| | | |
|---|---|---|
| http://demosite1.com/pkc/ | Digital certificate | 28 |
| | authentication | |
| http://demosite1.com/vine/ | Biometrics | 21 |
| | authentication | |
| http://demosite1.com/idpw/ | First password | 57 |
| | authentication | |
| http://demosite2.com/idpw/ | Second password | 79 |
| | authentication | |

The Table 3 shows an example of the data content of the tables in the authentication collaboration server 2.

The authentication request policy table 28 stores the information corresponding to the service ID, the application server 1, and the policy.

The item “service ID” indicates the ID for identifying the service provided by the application server 1.

The item “application server” indicates the application server 1 that provides the service of the item “service ID”. For example, the application server 1x provides the service of the service ID “first service ID”. The application server 1y provides the service of the service ID “second service ID”.

The item “policy” is the abbreviation for authentication request policy, indicating the combination of the type of the authentication method (password authentication, digital certificate authentication, biometrics authentication, and the like) that is necessary to provide the service of the item “service ID” to the user terminal 8, and the number of times the authentication is performed.

The authentication state table 27 manages the user ID, and the result of success in the authentication of the user shown in the table 2 (user authentication state). For example, the authentication assertion, which is the result of the success in two authentication attempts (first password authentication, second password authentication), is mapped to the user “taro”.

The authentication server list 29 manages the URL of the authentication server 4, together with the authentication method provided by the authentication server 4 as well as the number of corresponding services. The item “number of corresponding services” indicates the number of application servers 1 that can use the authentication server 4. The authentication server 4 to be used is determined by the number of authentication servers 1, from the largest to the smallest.

TABLE 4
34 Application detection table

| User ID for application | | Secret authentication |
|---|---|---|
| detection | Authentication method | information |
| Hash value of user ID | Digital certificate | 0-th secret |
| “hanako” | authentication | authentication |
| njxxzpmmbol7 | | information |
| | | Mmjpog4lbjc2qj90 |
| | | Ua7esypr2onxs |
| Hash value of user ID | First password | First secret |
| “taro” | authentication | authentication |
| qnls85o5mftw | | information |
| | | D7xlk9s9bckz2rkf |
| | | Opt5uizisz3vhiy |
| Hash value of user ID | Second password | Second secret |
| “taro” | authentication | authentication |
| qnls85o5mftw | | information |
| | | Rc4liazpxls0lar3 |
| | | 2ugmnz6dtxav2p |

The Table 4 shows an example of the data content of the application detection table 34. The application detection table 34 associates the authentication method by which the user has performed the authentication, with the secret authentication information generated from the authentication result for each user ID for application detection that corresponds to the user ID. Note that the information corresponding to the user ID and the application detection user ID is managed by the ID management unit 23.

TABLE 5

| | |
|---|---|
| | Hash value of authentication |
| User ID | information |

45a Authentication information table

| | |
|---|---|
| First user ID | First hash value |
| taroauth1 | 50j89qbqmnnwjh3r |
| | 8a1gm90xoj1qp |
| . | . |
| . | . |
| . | . |

45b Authentication information table

| | |
|---|---|
| Seconds user ID | Second hash value |
| taroauth2 | b4g0fignyt7hb6 |
| | qb9l6uuswr9e3cy |
| . | . |
| . | . |
| . | . |

The Table 5 shows an example of the data content of the authentication information table 45 stored in each authentication server 4. The authentication information table 45 associates the hash value, which is generated from the authentication information corresponding to the user ID of each authentication server 4, with the particular user ID.

The authentication information table 45a stores the data corresponding to the first user ID and the first hash value generated from the first authentication information.

The authentication information table 45b stores the data corresponding to the second user ID and the second hash value generated from the second authentication information.

The first user ID and the second user ID are used by the same user ID “taro”.

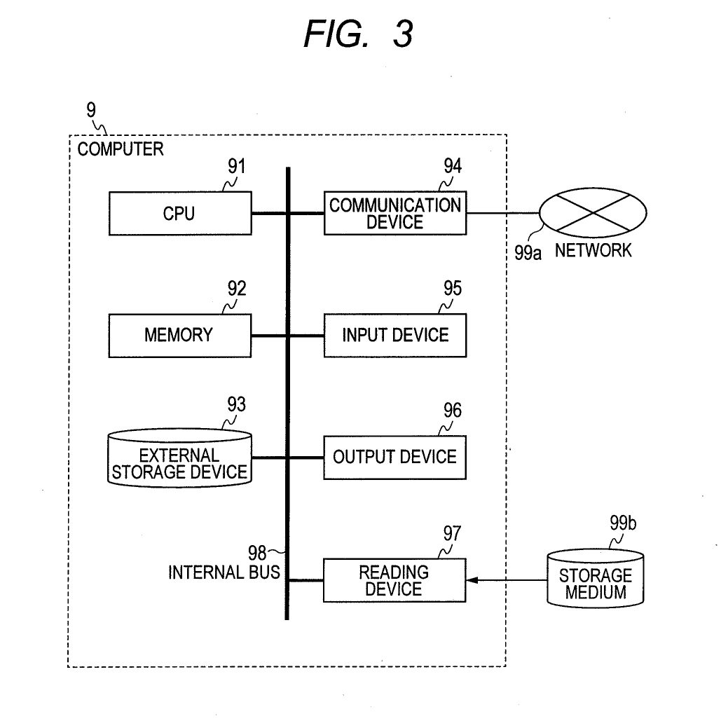

FIG. 3 is a hardware block diagram of each computer constituting the authentication collaboration system according.

A computer 9 includes a CPU 91, a memory 92, an external storage device 93 such as a hard disk, a communication device 94 for communicating with the other device through a network 99a such as the Internet or LAN, an input device 95 such as a key board or mouse, an output device 96 such as a monitor or printer, and a reading device 97 for a portable storage medium 99b. Then, all the components are connected by an internal bus 98. Examples of the storage medium 99b are an IC card and a USB memory.

The computer 9 loads a program for realizing the function of each processor shown in FIG. 2 into the memory 92, and executes the program by the CPU 91. The program may be stored in advance in the external storage device 93 of the computer 9, or may be downloaded to the external storage device 93 from the other device through the reading device 97 and the communication device 94 upon execution of the program.

Then, the program that is once stored in the external storage device 93, is loaded from the external storage device 93 into the memory, and than executed by the CPU 91. Alternatively, the program is directly loaded on the memory and then executed by the CPU 91 without being stored in the external storage device 93.

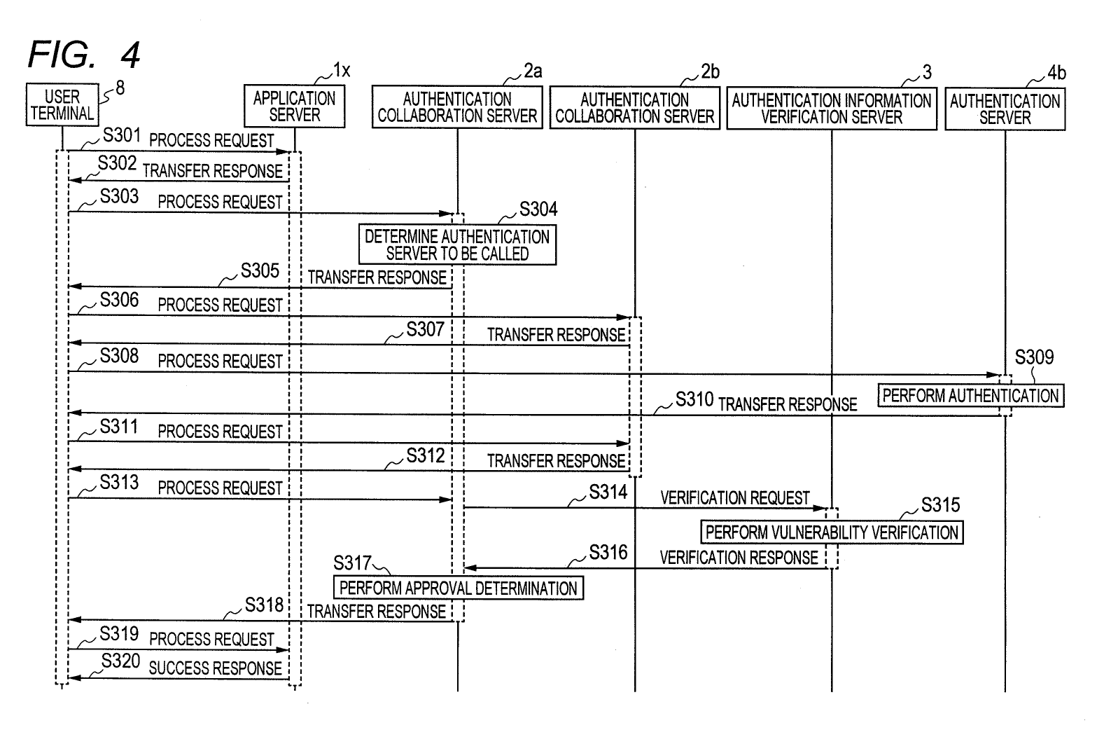

FIG. 4 is a flowchart of a process in which a user ID “taro” uses the service content of the first service ID. Although the details of FIG. 4 will be described below, the outline of the process of FIG. 4 is as follows.

First, since the policy of the first service ID requires “one-time password authentication” in the authentication request policy table 28, the URL “http://demosite2.com/idpw/” of the authentication server 4b with the largest number of corresponding services (79 services) is obtained from the authentication server list 29, to serve as the authentication server 4 for obtaining the “password authentication”.

Then, when the second password authentication is successfully completed by the authentication server 4b (authentication in the Table 2), and if the verification of the second authentication information used in the second password authentication is successful (unit verification, application verification in the Table 2), the user authentication state corresponding to the user ID “taro” in the authentication state table 27 is updated to “second password authentication” from “(unauthenticated)”. In this way, the user authentication state “second password authentication” satisfies the policy “one-time password authentication”, so that the user ID “taro” can use the service content of the first service ID from the application server 1x.

TABLE 6
Communication message list

| | Cate- | | |
|---|---|---|---|
| Name | gory | Type | Description |
| Process request | HTTP | GET | Store parameters relating to the |
| | | | requested process in a query. Note |
| | | | that when the message is transmitted |
| | | | to a destination specified by a |
| | | | transfer response, the source of the |
| | | | transfer response is set in the |
| | | | Referer header to notify the |
| | | | destination of the source of the |
| | | | message. |
| Transfer | HTTP | 302 | Response to the process request. The |
| response | | Moved | message asks for transfer to the other |
| | | Temporarily | device. The destination is specified |
| | | | in the Location header. |
| Success | HTTP | 200 OK | Response to the process request, in |
| response | | | which the service content is included. |
| Prohibition | HTTP | 403 | Response to the process request, which |
| response | | Forbidden | has no access authority. |
| Verification | SOAP | authResult- | Specify secret authentication |
| request | | VerifyRequest | information. Request verification |
| | | | (application verification, unit |
| | | | verification) of the vulnerability of |
| | | | the authentication information that is |
| | | | the source of the particular secret |
| | | | authentication information. |
| Verification | SOAP | authResult- | Response to the verification request. |
| response | | VerifyResponse | As the verification result of the |
| | | | vulnerability, “vulnerable” is stored |
| | | | when the authentication information is |
| | | | determined to be vulnerable in at |
| | | | least one of the application |
| | | | verification and the unit |
| | | | verification, or “invulnerable” is |
| | | | stored when the authentication |
| | | | information is determined to be |
| | | | invulnerable in both of the |
| | | | verifications. |

The Table 6 shows the specifications for each communication message used in the flowcharts described in FIG. 4 and the following figures.

Each data piece shown in the “name” of the Table 6 is included in the communication message of the format specified by the category of the protocol and the type of the protocol. Then, the communication message is transmitted.

As the category of the protocol, Hypertext Transfer Protocol (HTTP) is defined by RFC2616 in the standards body IETF.

Simple Object Access Protocol (SOAP) is the communication protocol specified by the standards body W3C to call data and service on the other communication device. The message transmitted and received between the communication devices is described in the Extensible Markup Language (XML).

The verification request includes tags that are enumerated in the following order between <authResultVerfyRequest> and </authResultVerifyRequest>.

<authUserID> “first user ID (taroauth1)” </authUserID>

<SAML:Assertion> “authentication result issued by the authentication server 4” </SAML:Assertion>

<credential> “secret authentication information” </credential>

<credentialProperties> “authentication information property” </credentialProperties>

The verification response includes tags that are enumerated in the following order between <authResultVerifyResponse> and </authResultVerifyResponse>. <result> “vulnerability verification result” </result>

Note that the value of “invulnerable” or “vulnerable” is stored in the vulnerability verification result.

TABLE 7
Content of the communication messages in FIG. 4

| | | | Session |
|---|---|---|---|
| Step | Category | Query | ID |
| S301 | Process request | User ID, service execution | |
| | | parameters | |
| S302 | Transfer response | User ID, service ID | c1 |
| S303 | Process request | User ID, service ID | |
| S305 | Transfer response | Second user ID, URL of | c2 |
| | | authentication server 4a | |
| S306 | Process request | Second user ID, URL of | |
| | | authentication server 4b | |
| S307 | Transfer response | Second user ID, URL of | c3 |
| | | authentication server 4b, URL of | |
| | | authentication collaboration | |
| | | server 2a | |
| S308 | Process request | Second user ID, URL of | |
| | | authentication server 4b, URL of | |
| | | authentication collaboration | |
| | | server 2a | |
| S310 | Transfer response | Authentication result A1, second | c4 |
| | | user ID, second secret | |
| | | authentication information, | |
| | | second authentication information | |
| | | property, URL of authentication | |
| | | collaboration server 2a | |
| S311 | Process request | Authentication result A1, second | c3 |
| | | user ID, second secret | |
| | | authentication information, | |
| | | second authentication information | |
| | | property, URL of authentication | |
| | | collaboration server 2a | |
| S312 | Transfer response | Authentication result A2, second | c3 |
| | | user ID, second secret | |
| | | authentication information, | |
| | | second authentication information | |
| | | property | |
| S313 | Process request | Authentication result A2, second | c2 |
| | | user ID, second secret | |
| | | authentication information, | |
| | | second authentication information | |
| | | property | |
| S314 | Verification request | Authentication result A2, user ID | |
| | | for application detection, second | |
| | | secret authentication | |
| | | information, second | |
| | | authentication information | |
| | | property | |
| S316 | Verification | Verification result | |
| | response | | |
| S318 | Transfer response | Approval determination result B1 | c2 |
| S319 | Process request | Approval determination result B1 | c1 |
| S320 | Success response | Service content | c1 |

The Table 7 shows the content (classification, query, session ID) of the communication message for each step in FIG. 4 described below. Note that “service ID” in FIG. 4 is the ID for the first service provided by the application server 1x.

In this embodiment, as an example, the HTTP binding is used for data transfer between the user terminal 8 and other devices.

The session ID is the connection identifier (Set-Cookie value) that is shared with the user terminal 8, which is newly generated by the source device of the transfer response generates. The source device notifies the user terminal 8 of the session ID (for example, “c1” first appearing in S302), and then receives the notification of the session ID from the user terminal 8 (for example, “c1” included in the process request in S319).

Note that in each flowchart in this specification, the activation period in each session is indicated by a dashed rectangular. For example, in the operation of the user terminal 8 in FIG. 4, the period from the start point (S301) to the end point (S320) is indicated by the dashed rectangular. In other words, the session of the session ID=“c1” is activated in the period indicated by the dashed rectangular.

The source device of the transfer response specifies the destination (Location header value) to which the response request is next transmitted, to the reception device of the transfer response (the user terminal 8). The reception device of the transfer response specifies the identifier of the source device of the transfer response as the source (Referer header value) from which the process request is next transmitted. In this way, the reception device of the process request can specify the source device.

Now returning to FIG. 4, as S301, the Web browser 81 of the user terminal 8 transmits a process request to the application server 1x according to the operation of the user.

As S302, an SAML SP unit 11x of the application server 1x transmits a transfer response to the Web browser 81. This transfer response is a message indicating that the user terminal 8 is not authenticated. This can be confirmed by the fact that the application server 1x failed to find the registration of the user ID of the user terminal 8 as well as the authentication determination result from the access table 13x.

As S303, the Web browser 81 transmits a process request to the authentication collaboration server 2a.

As S304, a location management unit 22a searches the authentication server list 29a for the URL of the authentication server 4, based on the authentication method of the authentication server 4 to collaborate with. Then, the location management unit 22a determines the authentication server 4 to be called. The determined authentication server 4 is the device that performs the additional authentication required to achieve the process request of S303.

As S305, an SAML IdP Proxy unit 25a of the authentication collaboration server 2a transmits a transfer response to the Web browser 81.

As S306, the Web browser 81 transmits a process request to the authentication collaboration server 2b.

As S307, an SAML IdP Proxy unit 25b transmits a transfer response to the Web browser 81. Note that a location management unit 22b analyzes the URL of the authentication server 4b to confirm that the domain of the authentication server 4b is present on the other domain (domain B).

As S308, the Web browser 81 transmits a process request to the authentication server 4b.

As S309, an authentication unit 43b of the authentication server 4b obtains the authentication information from the user terminal 8, and then performs user authentication. Since the data corresponding to the second user ID and the second hash value is present in the authentication information table 45b, the authentication unit 43b generates an authentication assertion specified by SAML 2.0, indicating authentication success. Then, the authentication unit 43 includes the authentication assertion in the second authentication result.

An authentication information secrecy unit 42b encrypts the second hash value of the authentication information table 45b, and generates the second secret authentication information.

An authentication information management unit 41b extracts features from the second authentication information, and generates the second authentication information property.

As S310, an SAML IdP unit 44b transmits a transfer response (including the generated second secret authentication information and the generated second authentication information property) to the Web browser 81.

As S311, the Web browser 81 transmits a process request to the authentication collaboration server 2b.

As S312, the SAML IdP Proxy unit 25b transmits a transfer response to the Web browser 81.

As S313, the Web browser 81 transmits a process request to the authentication collaboration server 2a.

As S314, an authentication information verification request unit 26a transmits a verification request to the authentication information verification server 3.

As S315, the application detection management unit 31 performs verification of the vulnerability.

As S316, the communication unit 33 transmits a verification response to the authentication collaboration server 2a.

As S317, an approval determination unit 24a performs approval determination.

As S318, the SAML IdP Proxy unit 25a transmits a transfer response to the Web browser 81.

As S319, the Web browser 81 transmits a process request to the application server 1x.

As S320, the SAML SP unit 11x transmits a success response to the Web browser 81. The body part of the success response includes the service content generated by a Web server 12x from the service execution parameters of S301. The Web browser 81 processes the received service content in the success response. Then, the result is displayed on the Web browser 81.

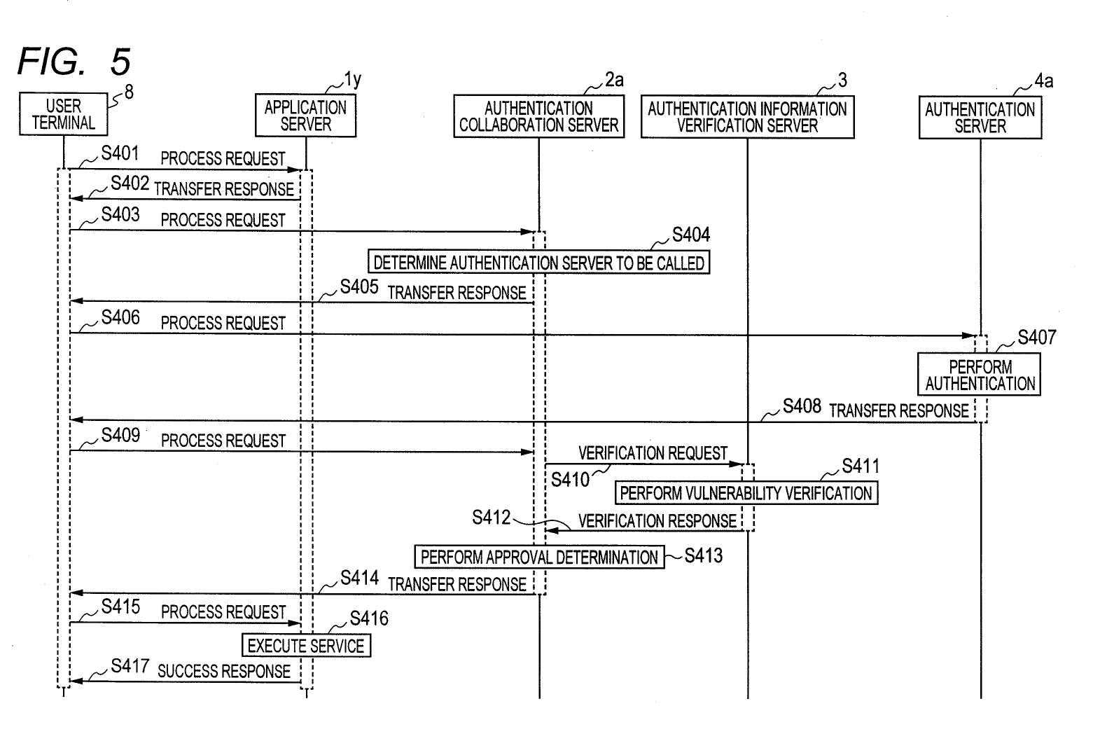

FIG. 5 is a flowchart of an example in which the user ID “taro” uses the service content of the second service ID after execution of the process in FIG. 4. The flowchart of FIG. 5 shows the operation in which the user performs authentication using the authentication server 4a of the own domain, and uses the service provided by the application server 1y. Although the details of FIG. 5 will be described below, the outline of the process in FIG. 5 is as follows.

First, since the policy of the second service ID requires “two-time password authentication” in the authentication request policy table 28, only the user authentication state “second password authentication” is not enough for the policy, requiring another attempt of password authentication. Thus, the URL “http://demositel.com/idpw/” of the authentication server 4a with the second largest number of corresponding services (57 services) is obtained from the authentication server list 29 (Table 3) for the second password authentication.

Then, when the first password authentication by the authentication server 4a is successful (authentication in the Table 2), and if the unit verification of the second authentication information used in the first password authentication as well as the application verification of the combination of the first authentication information and the second authentication information are successful, the user authentication state corresponding to the user ID “taro” in the authentication state table 27 (Table 3) is updated from “second password authentication” to “first password authentication, second password authentication”. In this way, the user authentication state “first password authentication, second password authentication” satisfies the policy “two-time password authentication”. Thus, the user ID “taro” can use the service content of the second service ID from the application server 1y.

TABLE 8
Content of the communication messages in FIG. 5

| | | | Session |
|---|---|---|---|
| Step | Category | Query | ID |
| S401 | Process request | User ID, service execution | |
| | | parameters | |
| S402 | Transfer response | User ID, service ID | c5 |
| S403 | Process request | User ID, service ID | c2 |
| S405 | Transfer response | First user ID, URL of | c2 |
| | | authentication server 4a | |
| S406 | Process request | First user ID, URL of | |
| | | authentication server 4a | |
| S408 | Transfer response | Authentication result A3, first | c6 |
| | | user ID, first secret | |
| | | authentication information, | |
| | | first authentication | |
| | | information property | |
| S409 | Process request | Authentication result A3, first | c2 |
| | | user ID, first secret | |
| | | authentication information, | |
| | | first authentication | |
| | | information property | |
| S410 | Verification request | Authentication result A3, user | |
| | | ID for application detection, | |
| | | first secret authentication | |
| | | information, first | |
| | | authentication information | |
| | | property | |
| S412 | Verification response | Verification result | |
| S414 | Transfer response | Approval determination result | c2 |
| | | B2 | |
| S415 | Process request | Approval determination result | c5 |
| | | B2 | |
| S417 | Success response | Service content | c5 |

The table 8 shows the content (category, query, session ID) of the communication message of each step in FIG. 5 described below. Note that “service ID” in FIG. 5 is the ID for the second service provided by the application server 1y.

As S401, the Web browser 81 of the user terminal 8 transmits a process request to the application server 1y.

As S402, an SAML SP unit 11y of the application server 1y transmits a transfer response to the Web browser 81. Here, similar to S302, the SAML SP unit 11y refers to an access table 13y to confirm that the user terminal is not authenticated.

As S403, the Web browser 81 transmits a process request to the authentication collaboration server 2a.

As S404, the location management unit 22a of the authentication collaboration server 2a determines the authentication server 4 to be called.

As S405, the SAML IdP Proxy unit 25a transmits a transfer response to the Web browser 81.

As S406, the Web browser 81 transmits a process request to the authentication server 4a.

As S407, an authentication unit 43a of the authentication server 4a obtains the authentication information from the user terminal 8, and then performs user authentication. Since the data corresponding to the first user ID and the first hash value is present in the authentication information table 45a, the authentication unit 43a generates an authentication assertion specified by SAML 2.0, indicating authentication success. Then, the authentication unit 43a includes the generated assertion in the first authentication result.

As S408, an SAML IdP unit 44a transmits a transfer response to the Web browser 81. Note that each parameter included in the transfer response of S408 is generated as follows. An authentication information secrecy unit 42a encrypts the first hash value of an authentication information table 45a. In this way, the authentication information secrecy unit 42a generates the first secret authentication information. An authentication information management unit 41a extracts features from the first authentication information, and generates the first authentication information property.

As S409, the Web browser 81 transmits a process request to the authentication collaboration server 2a.

As S410, the SAML IdP Proxy unit 25a transmits a verification request to the authentication information verification server 3.

As S411, the application detection management unit 31 performs verification of the vulnerability.

As S412, the communication unit 33 transmits a verification response to the authentication collaboration server 2a.

As S413, the approval determination unit 24a performs approval determination.

As S414, the SAML IdP Proxy unit 25a transmits a transfer response to the Web browser 81.

As S415, the Web browser 81 transmits a process request to the application server 1y.

As S416, a Web server 12y performs the service.

As S417, the SAML SP unit 11y transmits a success response to the Web browser 81. The body part of the success response includes the service content generated by the Web server 12y from the service execution parameters of S401. The Web browser 81 processes the received service content of the success response. Then, the result is displayed on the Web browser 81.

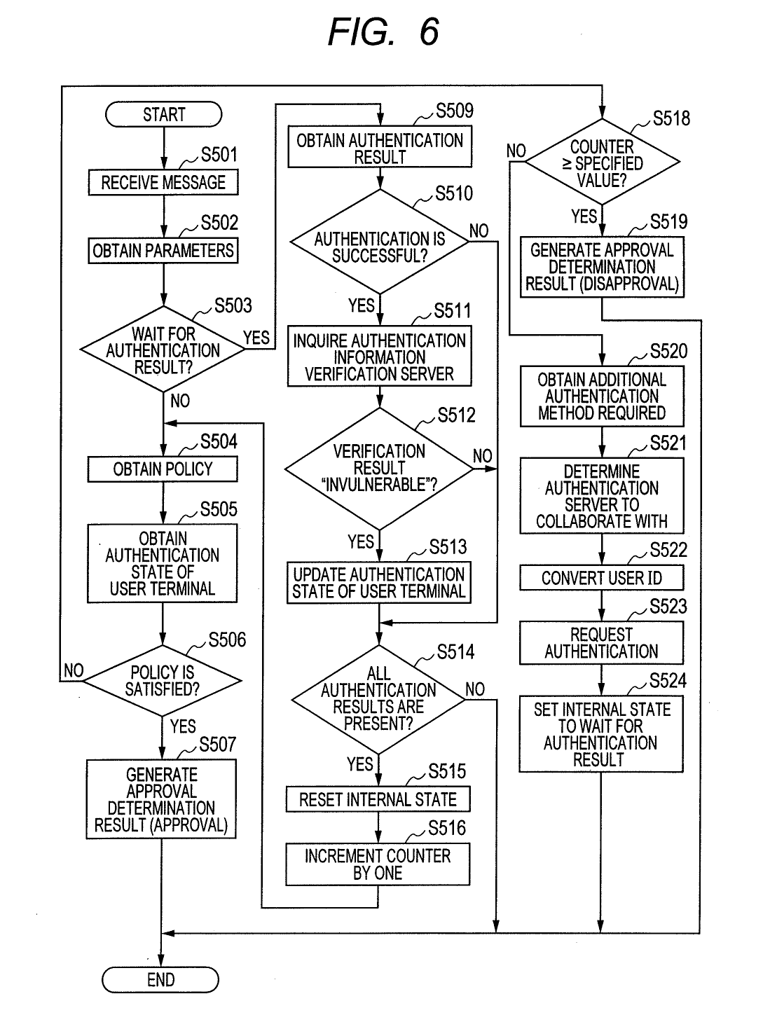

FIG. 6 is a flowchart of the operation of the authentication collaboration server 2 in the processes shown in FIGS. 4 and 5. The authentication collaboration server 2 determines whether the user terminal 8 should be authenticated. Based on the result of the determination, the authentication collaboration server 2 performs an access approval determination to the application server. FIG. 6 focuses on the following four cases that have been described in FIGS. 4 and 5.

Case 1: from the process request in S303 to the transfer response in S312
Case 2: from the process request in S313 to the transfer response in S318
Case 3: from the process request in S403 to the transfer response in S408
Case 4: from the process request in S409 to the transfer response in S414

The SAML IdP Proxy unit 25 receives the process request of each of the four cases (S501), obtains the message parameters included in the process request (S502), and determines whether the internal state stored on the memory is wait for the authentication result (S503). If YES in S503 (Case 2, Case 4), the process proceeds to S509. If NO in S503 (Case 1, Case 3), the process proceeds to S504.

As A504, the authentication state management unit 21 searches the authentication request policy table 28 for the policy based on the service ID (first service ID). Then, the authentication state management unit 21 obtains the policy of the application server 1 (“one-time password authentication” for the Case 1, or “two-time password authentication” for the Case 3).

As S505, the authentication state management unit 21 searches the authentication state table 27 based on the user ID (taro). Then, the authentication state management unit 21 obtains the authentication state of the user terminal 8 (“unauthorized” for the Case 1, or “second password authentication” for the Case 3). As S506, the approval determination unit 24 determines whether the authentication state of S505 satisfies the policy of S504. This is determined by whether the user authentication state satisfies all of the authentication requirements (the number of authentication attempts for each authentication category) described in the policy of the authentication state table 27. If YES in S506 (Case 2, Case 4), the process proceeds to S507. If NO in S506 (Case 1, Case 3), the process proceeds to S518.

In S507, the approval determination unit 24 generates an approval determination result (approval), and ends the process.

In S509, the SAML IdP Proxy unit 25 obtains the authentication result from the message of S501, and determines whether the obtained authentication result is authentication success (S510). If YES in S510, the SAML IdP Proxy unit 25 causes the ID management unit 23 to perform the process for converting the user ID of the user terminal 8 into the user ID for application detection for the authentication information verification server 3.

Then, the process proceeds to S511. If NO in S510, the process proceeds to S514.

In S511, the SAML IdP Proxy unit 25 calls the authentication information verification request unit 26. The authentication information verification request unit 26 generates a verification request, and transmits to the authentication information verification server 3 to inquire about the verification request (S314 in the Case 2, S410 in the Case 4).

The authentication information verification request unit 26 receives a verification response from the authentication information verification server 3 (S316 in the Case 2, S412 in the Case 4). The authentication state management unit 21 determines whether the verification result in the verification response is success (S512). If YES in S512, the process proceeds to S513. If NO in S512, the process proceeds to S514.

In S513, the authentication state management unit 21 updates the authentication state of the user terminal 8 by adding the record about the authentication state of the user terminal 8, to the authentication state table 27.

The authentication state management unit 21 determines whether the authentication results are returned from all the authentication servers 4 to which the authentication is requested (S514). If YES in S514, the authentication state management unit 21 resets the internal state (S515) and increments the authentication attempt counter by one (S516). Then, the process proceeds to S504. If No in S514, the process ends.

As S518, the authentication state management unit 21 determines whether the value of the authentication attempt counter stored on the memory is equal to or greater than a predetermined value (for example, 3 times). If YES in S518, the process proceeds to S519. If NO in S518, the process proceeds to S520.

In S519, the authentication state management unit 21 generates an approval determination result (disapproval), and then the process ends.

In S520 the approval determination unit 24 calculates the required authentication method to be added (S520). As S520, for example, when the current user authentication state is “first password authentication” while the policy requires “one-time digital certificate authentication, two-time password authentication”, the authentication required to be added is “one-time digital certificate authentication, one-time password authentication”.

As S521, the location management unit 22 obtains the URL of the authentication server 4 with the largest number of corresponding services (except the authentication server 4 in which the authentication result has been obtained) of the authentication methods required to be added.

As S522, the ID management unit 23 converts the user ID obtained from the user terminal 8 into the user ID (for example, first user ID) for the authentication server 4 that is determined in S521.

As S523, the SAML IdP Proxy unit 25 generates a transfer response and transmits to the user terminal 8 to ask for authentication (S305 in the Case 1, S405 in the Case 3). At the same time, the SAML IdP Proxy unit 25 sets the internal state determined in S503 to wait for authentication result (S524).

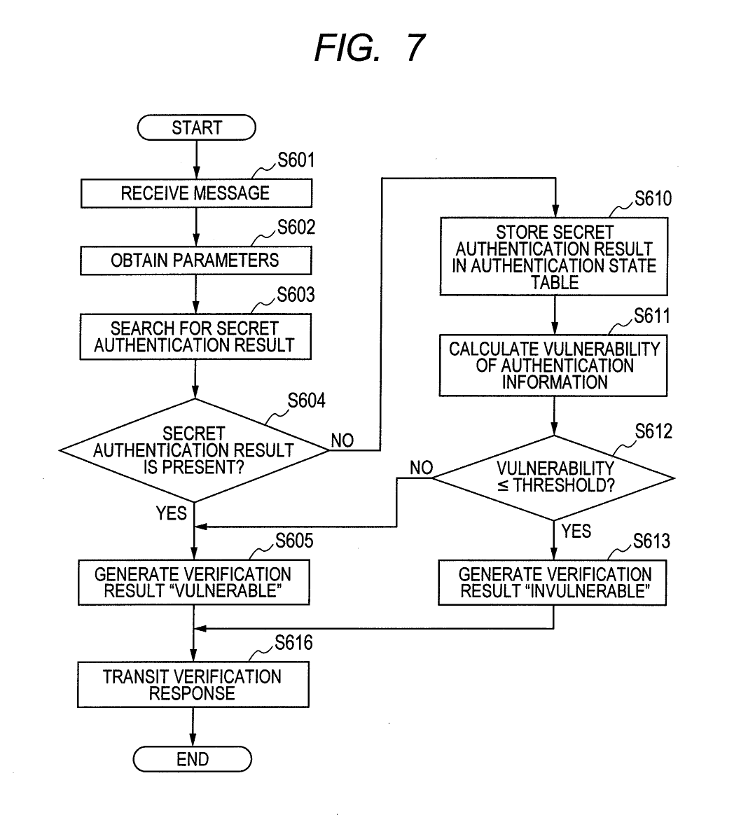

FIG. 7 is a flowchart of the operation of the authentication information verification server 3 in the processes shown in FIGS. 4 and 5. The outline of this flowchart is as follows. The authentication information verification server 3 performs a verification process (S315 in the Case 2, S411 in the Case 4) in response to the verification request (which is transmitted in S314 in the Case 2 described in FIG. 6, S410 in the Case 4 described in FIG. 6). Then, the authentication information verification server 3 transmits the result as the verification response (which is transmitted in S316 in the Case 2, S412 in the Case 4).

The communication unit 33 receives the verification request from the authentication collaboration server 2 (S601). Then, the communication unit 33 obtains the message parameters in the verification request (S602).

As the verification request of S601 in the Case 2, the message parameters “authentication result A2, user ID for application detection, second secret authentication information, and second authentication information property” are obtained (see the Table 7).

As the verification request of S601 in the Case 4, the message parameters “authentication result A3, user ID for application detection, first secret authentication information, and first authentication information property” are obtained (see the Table 8).

The application detection management unit 31 searches the application detection table 34 by using the application detection user ID obtained in S602 as the search key. Then, the application detection management unit 31 obtains the secret authentication information stored in the secret authentication information row of the corresponding record, as the search result (S603). Then, the application detection management unit 31 compares the secret authentication information obtained in S602 with the secret authentication information obtained in S603. In this way, the application detection management unit 31 determines whether the secret authentication information in the verification request is present in the application detection table 34 (S604). In other words, the determination process of S604 is the process for determining whether the same authentication information is applied by the same user.

If YES in S604, the process proceeds to S605. If NO in S604, the process proceeds to S610.

As the determination result of S604 in the Case 2, the “second secret authentication information” obtained in S602 is not present in the secret authentication information “0-th secret authentication information” that is obtained in S603, so that the answer is NO in S604.

As the determination result of S604 in the Case 4, the “first secret authentication information” obtained in S602 is not present in the secret authentication information “0-th secret authentication information, second secret authentication information” that is obtained in S603, so that the answer is NO in S604.

As S605, the application detection management unit 31 generates a verification result (“vulnerable”), and then proceeds to S616.

In S610, the application detection management unit 31 adds the record (secret authentication result) about the message parameters obtained in S602, to the application detection table 34.

As the addition process of S610 in the Case 2, the “second secret authentication information” obtained in S602 is added to the application detection table 34. As a result, the secret authentication information of the application detection table 34 is updated to “0-th secret authentication information, second secret authentication information”.

As the addition process of S610 in the Case 4, the “first secret authentication information” obtained in S602 is added to the application detection table 34. As a result, the secret authentication information of the application detection table 34 is updated to “0-th secret authentication information, first secret authentication information, and second secret authentication information”.

The authentication information verification unit 32 calculates the vulnerability of the authentication information from the authentication information property obtained in S602 (S611). First, if the authentication information is password, the authentication information verification unit 32 calculates the vulnerability values for each of the individual properties, such as the length of the character string, and the type of the used characters. Then, the authentication information verification unit 32 calculates the sum of the vulnerable values as the vulnerability of the authentication information.

The authentication information verification unit 32 determines whether the vulnerability calculated in S611 exceeds a threshold (vulnerability≦threshold) (S612). If YES in S612, the process proceeds to S613. If NO in S612, the process proceeds to S605.

As S613, the authentication information verification unit 32 generates a verification result (“invulnerable”).

As S616, the communication unit 33 generates a verification response including the verification result generated in S605 or S613, and transmits to the authentication collaboration server 2. Note that the verification response of S316 is transmitted as S616 in the Case 2, while the verification response of S412 is transmitted as S616 in the Case 4.

As described above, in the authentication collaboration system described in the first embodiment, the authentication information verification server 3 compares the first secret authentication information with the second secret authentication information, to verify application between the two pieces of authentication information (first authentication information, second authentication information) that are used by the same user. In this way, it is possible to disable the user authentication using the vulnerable authentication information in which application is detected. As a result, it is possible to prevent the reduction in the security when a plurality of user authentication results are combined and used together.

Now, a second embodiment will be described below. The second embodiment is a configuration in which a plurality of single sign-on systems operate in collaboration with each other.

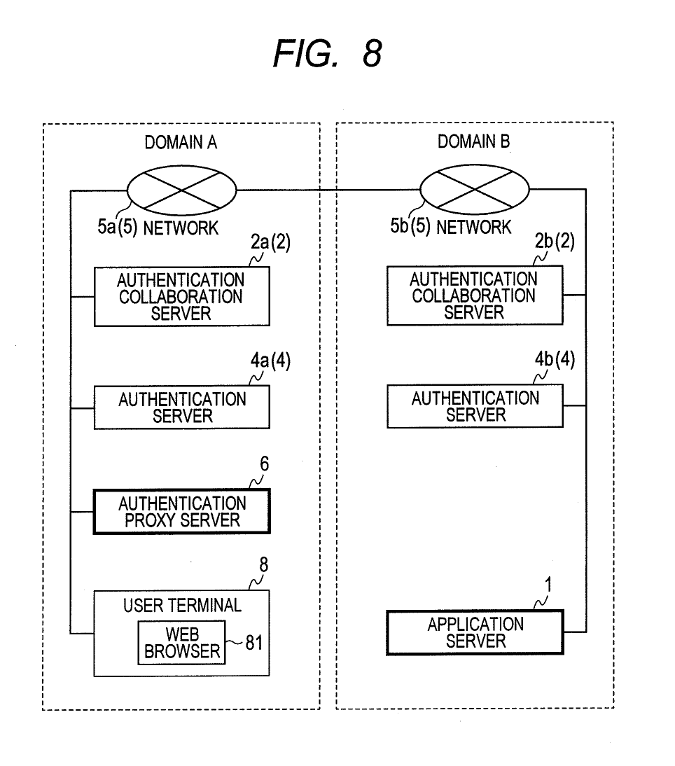

FIG. 8 is a block diagram of an authentication server collaboration system according to the second embodiment. The authentication server collaboration system is designed to provide single sing-on between domains.

In the case in which the user terminal 8 and the authentication server 4 belong to different domains, when the user terminal 8 performs an authentication to the authentication server 4, an authentication proxy server 6 of the domain to which the user terminal 8 belongs, performs the authentication with the authentication server 4 of the other domain, in place of the user terminal 8.

Here is an example in which the user terminal 8 belongs to the domain A (the network 5a) and the authentication server 4 belongs to the domain B (the network 5b). When the authentication with the authentication server 4b is successful, the user terminal 8 can receive the service from the application server 1 in the domain B.

The same components in the first and second embodiments are denoted by the same reference numerals and the description thereof will be omitted. Further, in the following description, similar to the first embodiment, when the same component exists in the two domains, the suffix “a” or “b” of the component represents the domain to which the particular component belongs. When the first and second embodiments are compared, there are three differences in the configuration as follows.

As Difference 1, the connection destination of the application server 1 is changed from the domain A to the domain B.

As Difference 2, the authentication information verification server 3 is omitted. At the same time, the authentication information verification request unit 26 for communicating with the authentication collaboration server 2 in the authentication collaboration server 2 is also omitted.

Thus, the verification process by the authentication collaboration server 2, which is described in the first embodiment, is omitted in the second embodiment. More specifically, the steps of verification request (S314, S410), verification process (S315, S411), and verification response (S316, S412) are omitted. If the authentication result included in S502 is authentication success (YES in S510), the data is updated to the authentication result as the authentication state of the user (S513), without performing the steps of verification request (so that S511 and S512 are omitted). In other words, the steps of S511 and S512 are omitted.

As Difference 3, the authentication proxy server 6 is newly added to the domain A. Note that it is also possible, instead of providing the authentication proxy server 6 in the domain A, to place the authentication proxy server 6 in each of the two domains, or to place the authentication proxy server 6 and the authentication collaboration server 2 in the same package.

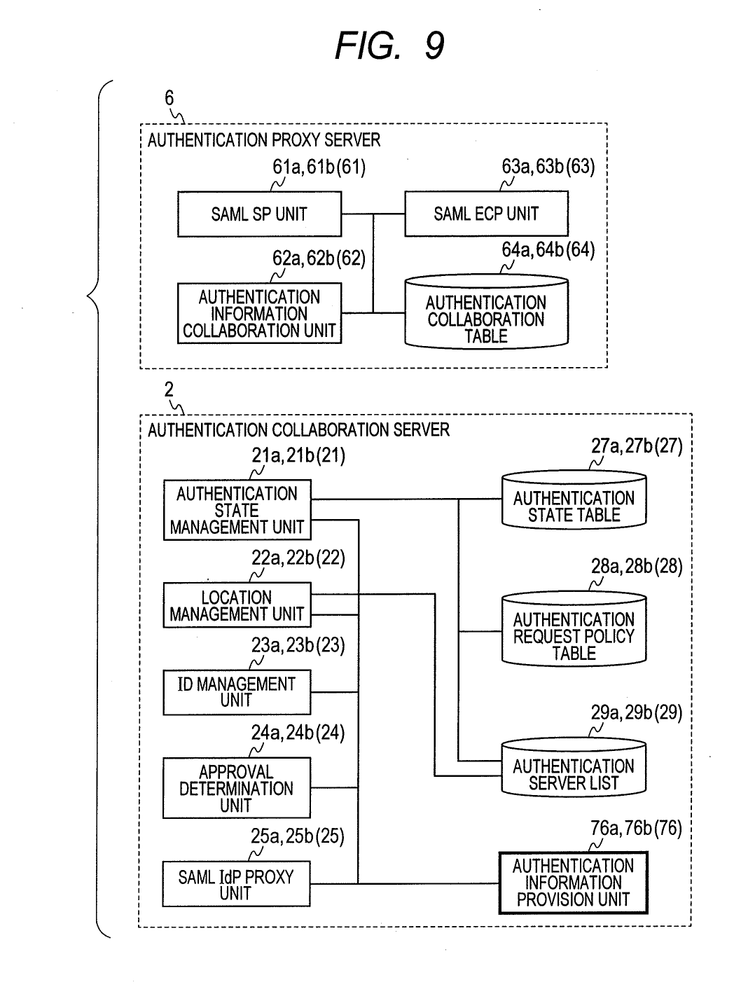

FIG. 9 is a block diagram of the components constituting the authentication server collaboration system according to the second embodiment. The same components as those of the first embodiment are omitted in FIG. 9.

The authentication proxy server 6 performs user authentication on the network 5b, in place of the user terminal 8, by controlling the access from the network 5a to the network 5b.

Thus, the authentication proxy server 6 includes an SAML SP unit 61, an authentication information collaboration unit 62, an SAML ECP unit 63, and an authentication collaboration table 64.

The SAML SP unit 61 obtains the approval determination result from the authentication collaboration server 2, and controls the access from the network 5a to the network 5b.

The authentication information collaboration unit 62 obtains the authentication result and the secret authentication information from the authentication collaboration server 2, and uses them in the user authentication on the network 5b.

The SAML ECP unit 63 performs the user authentication on the network 5b, in place of the user terminal 8.

Further, an authentication information provision unit 76 is newly added to the authentication collaboration server 2. The authentication information provision unit 76 transmits the authentication result issued by the authentication server 4, as well as the secret authentication information to the authentication proxy server 6.

TABLE 9
64 Authentication collaboration table

| | | | | | Approval |
|---|---|---|---|---|---|
| User | | Authentication | Type of | Authentication | determination |
| ID | Application server URL | collaboration | offering | method | result |
| hanako | http://demosite3.com/sp2/ | Present | Authentication | Digital | OK |
| | | | result | certificate | |
| | | | | authentication | |
| hanako | http://demosite4.com/sp3/ | Absent | | Biometrics | NG |
| | | | | authentication | |
| taro | http://demosite2.com/sp1/ | Present | Authentication | Password | OK |
| | | | information | authentication | |

The authentication collaboration table 64 shown in the Table 9 stores information necessary for the access control, as well as information used in the user authentication on the network 5b. In other words, the authentication collaboration table 64 stores information corresponding to the user ID, the URL of the application server 1, the authentication collaboration, the type of offering, the authentication method, and the approval determination result.

The item “user ID” stores the user ID that is used when the application server 1 is used.

The item “application server URL” stores the URL of the application server 1.

The item “presence or absence of authentication collaboration” stores the flag indicating whether the authentication result in the authentication server 4 on the network 5a, and the authentication information registered in the authentication server 4a are provided to the authentication server 4 on the other network.

The item “type of offering” stores the type of information (authentication information/authentication result) to be provided to the authentication server 4 on the other network.

The item “authentication method” stores the authentication method of the user authentication required by the application server 1.

The item “approval determination result” stores the approval determination result issued by the authentication collaboration server 2a.

TABLE 10
Parameter example for description in the second embodiment

| | | Authentication | Authentication |
|---|---|---|---|
| | User | server 4a | server 4b |
| | terminal 8 | (First password | (Second password |
| Item | (Application 1) | authentication) | authentication) |
| User ID | User ID | First user ID | Second user ID |
| | taro | taroauth1 | taroauth2 |
| Authentication | | First | Second |
| information | | authentication | authentication |
| | | information | information |
| | | taropw | taropw |
| Secret | | First secret | Second secret |
| authentication | | authentication | authentication |
| information | | information | information |
| | | d7xlk9s9bciz2rkf | d7xlk9s9bciz2rkf |
| | | opt5u1zisz3vhiy | opt5u1zisz3vhiy |
| Public key | | First public key | Second public key |
| certificate | | certificate | certificate |

The Table 10 shows a parameter example for description in the second embodiment. When comparing with the Table 1, the data of the authentication information and its secret authentication information corresponding to the first user ID are different from the data for the second user ID in the Table 1. While in the Table 10, the data for the first user ID is the same as the data for the second user ID.

In other words, in the first embodiment, it is desirable that the secret authentication information for the first user ID and the secret authentication information for the second user ID do not match, so that the authentication information is not applied to the same user. On the other hand, in the second embodiment, it is desirable that the secret authentication information for the first user ID match the secret authentication information for the second user ID, so that the authentication is successful for each of a plurality of domains with respect to the same user.

Further, in the second embodiment, the external storage device of the authentication proxy server 6 stores a first public key certificate of the authentication server 4a, as well as a second public key certificate of the authentication server 4b.

The authentication proxy server 6 controls so that the user terminal 8 can use the service of the application server 1 by the following procedures 1 to 3 (see FIG. 8). This eliminates the need for the user terminal 8 to input the own authentication information to the authentication server 4b.

Procedure 1: Determine that the user authentication is necessary in the access (service use) from the network 5a (the user terminal 8) to the network 5b (the application server 1).

Procedure 2: Perform user authentication in collaboration with the authentication collaboration server 2a and the authentication server 4a.

Procedure 3: Present the secret authentication information obtained from the authentication server 4a, to the authentication server 4b, to perform user authentication with the authentication server 4b, in place of the user terminal 8, on the network 5b.

TABLE 11
Communication message list (second embodiment)

| | Cate- | | |
|---|---|---|---|
| Name | gory | Type | Description |
| Secret | SOAP | assertionRequest | Request to obtain secret |
| authentication | | | authentication |
| information | | | information |
| request | | | |
| Secret | SOAP | assertionResponse | Response to the secret |
| authentication | | | authentication |
| information | | | information request, in |
| response | | | which the requested |
| | | | secret authentication |
| | | | information is included. |
| Secrecy | SOAP | credentialRequest | Request for data |
| request | | | corresponding to the |
| | | | ticket, using the ticket |
| | | | storing data as the key. |
| secrecy | SOAP | credentialResponse | Response to the secrecy |
| response | | | request, in which the |
| | | | requested ticket |
| | | | corresponding data is |
| | | | included. |
| Ticket storing | SAML | ArtifactResolve | Data storing the ticket |
| data | | | for obtaining the ticket |
| | | | corresponding data. |
| Ticket | SAML | ArtifactResponse | Data corresponding to |
| corresponding | | | the ticket in the ticket |
| data | | | storing data (certificate, |
| | | | etc.) |

The Table 11 shows the list of communication messages exchanged in the second embodiment.

The secret authentication information request shown in the first line of the Table 11 includes tags that are enumerated in the following order between <assertionRequest> and </assertionRequest>.

<samlp:ArtifactResolve> “ticket storing data (including the authentication thicket issued by the authentication collaboration server 2)” </samlp:ArtifactResolve>

<pkCertificate> “public key certificate of the authentication server 4”</pkCertificate>

Here, for example, the authentication ticket is an artifact specified in SAML 2.0, which is used in the process for obtaining the ticket corresponding data (such as the authentication information of the user terminal 8) that has been mapped to each authentication ticket.

Further, the secrecy request shown in the third line of the Table 11 includes data (ticket storing data, public key certificate) that is the same as the secret authentication information request.

The secrecy response shown in the fourth line of the Table 11 includes tags that are enumerated in the following order between <credentialResponse> and </credentialResponse>.

<result> “information indicating whether the secret authentication information is successfully obtained (“success” if it is successful, “fail” if it failed) </result>

<credential> “secret authentication information” </credential>

The secret authentication information response shown in the second line of the Table 11 includes tags that are enumerated in the following order between <assertionResponse> and </assertionResponse>.

<result> “information indicating whether the secret authentication information is successfully obtained (“success” if it is successful, “fail” if it failed)” </result>

<type> “type of the information included in the following credential tag (“assertion” indicating the authentication result, “credential” indicating the secret authentication information)”</type>

<credential> “authentication result or secret authentication information”</credential>

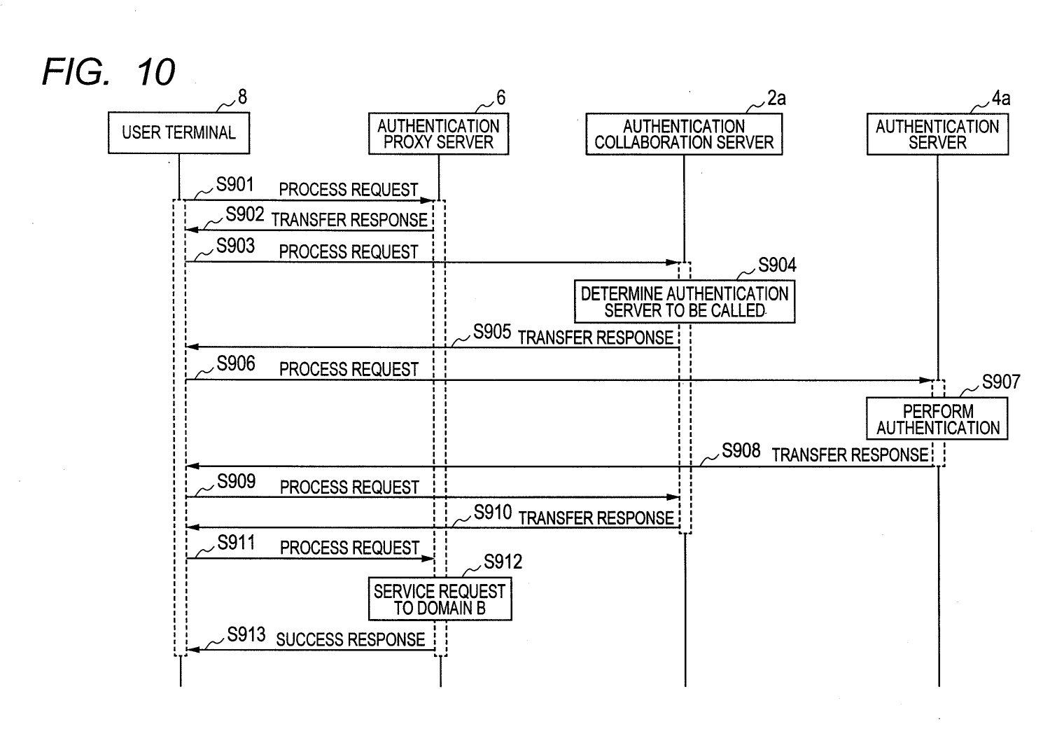

FIG. 10 is a flowchart of the process that is started on the side of the domain A in the second embodiment. At the start point of the flowchart, the approval determination result of the user ID “taro” in the authentication collaboration table 64 of the Table 9 is not described. The user ID “taro” is the user ID for the service provided by the application server 1.

TABLE 12
Content of the communication messages in FIG. 10

| | | | Session |
|---|---|---|---|
| Step | Category | Query | ID |
| S901 | Process request | User ID, service execution | |
| | | parameters | |
| S902 | Transfer response | User ID, service ID | c1 |
| S903 | Process request | User ID, service ID | |
| S905 | Transfer response | First user ID, URL of | c2 |
| | | authentication server 4a | |
| S906 | Process request | First user ID, URL of | |
| | | authentication server 4a | |
| S908 | Transfer response | Authentication result A1, | c3 |
| | | authentication ticket T1, | |
| | | first user ID | |
| S909 | Process request | Authentication result A1, | c2 |
| | | authentication ticket T1, | |
| | | first user ID | |
| S910 | Transfer response | Approval determination | c2 |
| | | result, authentication | |
| | | ticket T2 | |
| S911 | Process request | Approval determination | c1 |
| | | result, authentication | |
| | | ticket T2 | |
| S913 | Success response | Service content | c1 |

The Table 12 shows the content (category, query, session ID) of the communication message for each step shown in FIG. 10 described below.

As S901, the Web browser 81 of the user terminal 8 generates a process request by receiving an operation from the user of the user terminal 8, and transmits to the authentication proxy server 6.

As S902, the SAML SP unit 61 of the authentication proxy server 6 transmits a transfer response to the user terminal 8.

As S903, the Web browser 81 transmits a process request to the authentication collaboration server 2a.

As S904, similar to S304, the SAML IdP Proxy unit 25a of the authentication collaboration server 2a determines the authentication server 4a to be called.

As S905, the SAML IdP Proxy unit 25a transmits a transfer response to the user terminal 8.

As S906, the Web browser 81 transmits a process request to the authentication server 4a.

As S907, the authentication unit 43a of the authentication server 4a obtains the authentication information from the user terminal 8, and performs user authentication. In the user authentication, authentication success is determined when the record of combination between the first user ID and the corresponding authentication information (obtained from the user terminal 8) is found in the authentication information table 45a.

As S908, the SAML IdP unit 44a transmits a transfer response (including authentication result A1, authentication ticket T1, and first user ID) to the user terminal 8. The authentication result A1 is an authentication assertion specified in SAML 2.0. The authentication ticket T1 is an artifact specified in SAML 2.0. The authentication unit 43a associates the authentication ticket T1 with the authentication information of the user terminal 8, and temporarily stores in the memory.

As S909, the Web browser 81 transmits a process request to the authentication collaboration server 2a. The SAML IdP Proxy unit 25a receives the process request from the user terminal 8. Then, similar to S317 and S413 in the first embodiment, the SAML IdP Proxy unit 25a generates an approval determination result (approval) for the authentication proxy server 6. Further, an authentication information collaboration unit 62a generates an artifact specified in SAML 2.0, as authentication ticket T2. At the same time, the authentication information collaboration unit 62a associates the authentication ticket T2 with the authentication result issued by the authentication server 4a, and temporarily stores in the memory.

As S910, the SAML IdP Proxy unit 25a transmits a transfer response to the user terminal 8.

As S911, the Web browser 8 transmits a process request to the authentication proxy server 6. The SAML SP unit 61 receives the process request. Then, the SAML SP unit 61 obtains the message parameter included in the process request, and stores the message parameter in the memory.

As S912, the SAML SP unit 61 transmits a service request for the domain B to the network 5b. Then, the SAML SP unit 61 obtains the service content, which is the execution result of the service, from the application server 1.

As S913, the SAML SP unit 61 transmits a success response to the user terminal 8. The Web browser 81 processes the service content in the received success response, and displays the result on a screen of the user terminal 8.

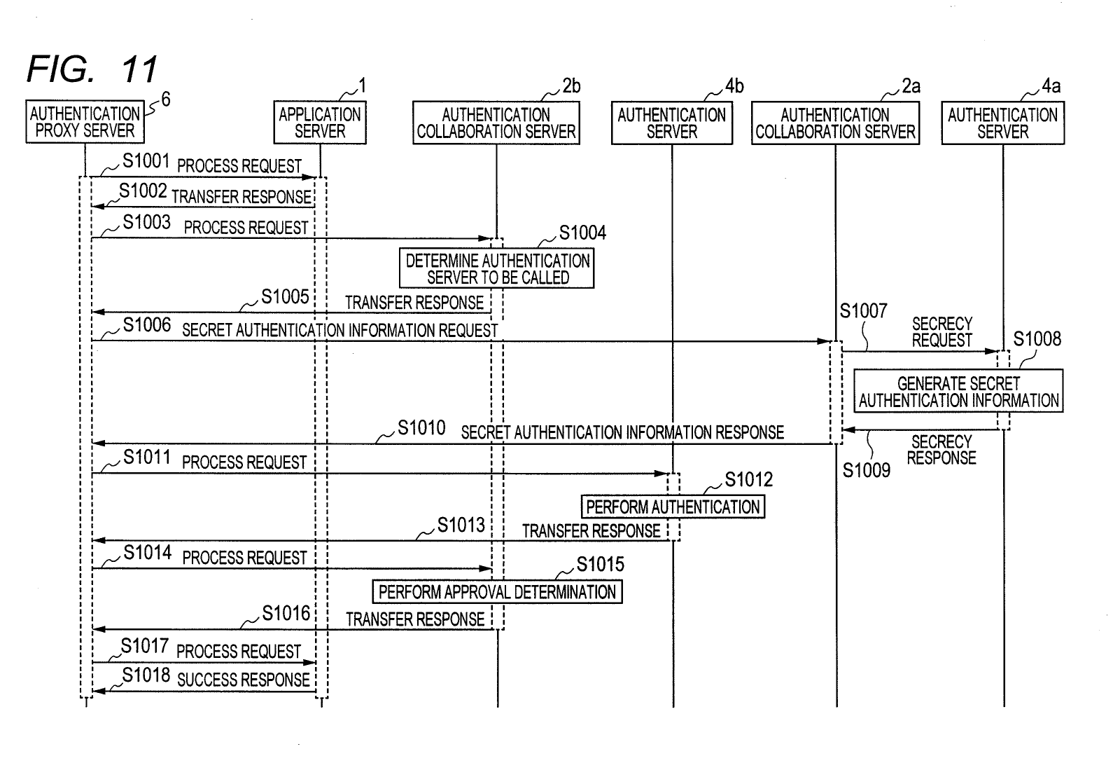

FIG. 11 is a flowchart of the process that is started on the side of the domain B after the service request for the domain B is transmitted (S912) in the second embodiment.

TABLE 13
Content of the communication messages in FIG. 11

| | | | Session |
|---|---|---|---|
| Step | Category | Query | ID |
| S1001 | Process request | User ID, service execution | |
| | | parameters | |
| S1002 | Transfer response | User ID, service ID | c4 |
| S1003 | Process request | User ID, service ID | |
| S1005 | Transfer response | Second user ID, URL of | c5 |
| | | authentication server 4b | |
| S1006 | Secret authentication | Authentication ticket T2, | |
| | information request | public key certificate of | |
| | | authentication server 4b | |
| S1007 | Secrecy request | Authentication ticket T1, | |
| | | public key certificate of | |
| | | authentication server 4b | |
| S1009 | Secrecy response | Secret authentication | |
| | | information | |
| S1010 | Secret authentication | Secret authentication | |
| | information response | information | |
| S1011 | Process request | Second user ID, URL of | |
| | | authentication server 4b, | |
| | | secret authentication | |
| | | information | |
| S1013 | Transfer response | Authentication result A2, | c6 |
| | | second user ID | |
| S1014 | Process request | Authentication result A2, | c5 |
| | | second user ID | |
| S1016 | Transfer response | Approval determination result | c5 |
| S1017 | Process request | Approval determination result | c4 |
| S1018 | Success response | Service content | c4 |

The table 13 shows the content (category, query, session ID) of the communication message for each step shown in FIG. 11 described below.

As S1001, the SAML ECP unit 63 transmits a process request to the application server 1.

As S1002, the SAML SP unit 11 confirms that the user ID and the approval determination result are not registered in the access table 13, so that the user terminal 8 is not authenticated. Then, the SAML SP unit 11 transmits a transfer response to the authentication proxy server 6.

As S1003, the SAML ECP unit 63 transmits a process request to the authentication collaboration server 2.

As S1004, similar to S404, the SAML IdP Proxy unit 25b determines the authentication server 4b to be called.

As S1005, the SAML IdP Proxy unit 25b transmits a transfer response to the authentication proxy server 6.

The authentication information collaboration unit 62 receives the transfer response of S1005. Then, the authentication information collaboration unit 62 determines whether the cell of the authentication collaboration presence or absence record is “present”, and whether the cell of the provision type record is “authentication information”, for the line in which the user ID and the URL of the application server 1 are stored. At the time of reception in S1005, the corresponding line is present in the authentication collaboration table 64 (the determination is YES). Thus, the authentication information collaboration unit 62 obtains the public key certificate of the authentication server 4b that is stored in the external storage device of the authentication proxy server 6.

The SAML SP unit 61 generates a ticket storing data of SAML 2.0 Artifact Resolution Protocol including the authentication ticket T2.

As S1006, the SAML SP unit 61 transmits a secret authentication information request (including the generated ticket storing data) to the authentication collaboration server 2a.

The SAML IdP Proxy unit 25a analyzes that the public key certificate is included in the received secret authentication information request. Then, the SAML IdP Proxy unit 25a generates a ticket storing data including the authentication ticket T1 obtained from the authentication server 4a.

On the other hand, if the public key certificate is not included in the secret authentication information request, the authentication information collaboration unit 62a obtains the authentication result temporarily stored in the memory together with the authentication ticket 2. Then, the authentication information collaboration unit 62a returns the obtained authentication result to the authentication proxy server 6.

As S1007, the SAML IdP Proxy unit 25a transits a secrecy request (including the generated ticket storing data) to the authentication server 4a.

The SAML IdP unit 44a obtains the secrecy request from the authentication collaboration server 2a. Then, the SAML IdP unit 44a obtains the authentication information of the user terminal 8 that is temporarily stored in the memory together with the authentication ticket T1.

As S1008, the authentication information secrecy unit 42a encrypts the authentication information of the user terminal 8 by using the public key present in the public key certificate of the authentication server 4b that is included in the secrecy request. In this way, the authentication information secrecy unit 42a generates secret authentication information.

The SAML IdP unit 44a generates a ticket corresponding data of SAML 2.0 Artifact Resolution Protocol, including the secret authentication information generated in S1008.

As S1009, the SAML IdP unit 44a transmits a secrecy response (including the generated ticket corresponding data) to the authentication collaboration server 2a.

The SAML IdP Proxy unit 25a generates a new ticket corresponding data including the secret authentication information in the received secrecy response.

As S1010, the SAML IdP Proxy unit 25a transmits a secret authentication information response (including the generated ticket corresponding data) to the authentication proxy server 6.

As S1011, the SAML SP unit 61 transmits a process request (including the secret authentication information obtained by the SAML SP unit 61 from the ticket corresponding data in the secret authentication information response) to the authentication server 4b.

As S1012, the authentication unit 43b decrypts the secret authentication information obtained from the authentication proxy server 6 by using the private key. Then, the authentication unit 43b performs user authentication using the obtained authentication information. If the authentication information (password) of the user terminal 8 registered in the authentication information table 45a is the same as the authentication information (password) obtained by decrypting the secret authentication information, the user authentication is successful. In the case of authentication success, the authentication unit 43b generates an authentication assertion including the authentication result A2.

As S1013, the SAML IdP unit 44b transmits a transfer response to the authentication proxy server 6.

As S1014, the SAML ECP unit 63 transmits a process request to the authentication collaboration server 2.

As S1015, similar to S317 and S413, the SAML IdP Proxy unit 25b performs approval determination.

As S1016, the SAML IdP Proxy unit 25b transmits a transfer response to the authentication proxy server 6.

As S1017, the SAML ECP unit 63 transmits a process request to the application server 1.

As S1018, the SAML SP unit 11 transmits a success response (including the service content generated by the Web server 12 from the service execution parameters included in the process request of S1017) to the authentication proxy server 6.

The SAML ECP unit 63 receives the success response from the application server 1. Then, the SAML ECP unit 63 generates a success response including the service content of the success response, and transmits to the user terminal 8 (S913).

Note that instead of starting S1001 after the steps S901 to S912 are performed, the following procedures 1 to 4 can be performed in this order.

### Procedure 1: Perform S901

### Procedure 2: Perform S1001 to S1005

### Procedure 3: Perform S902 to S911

Procedure 4: Perform S1006 and the following steps.

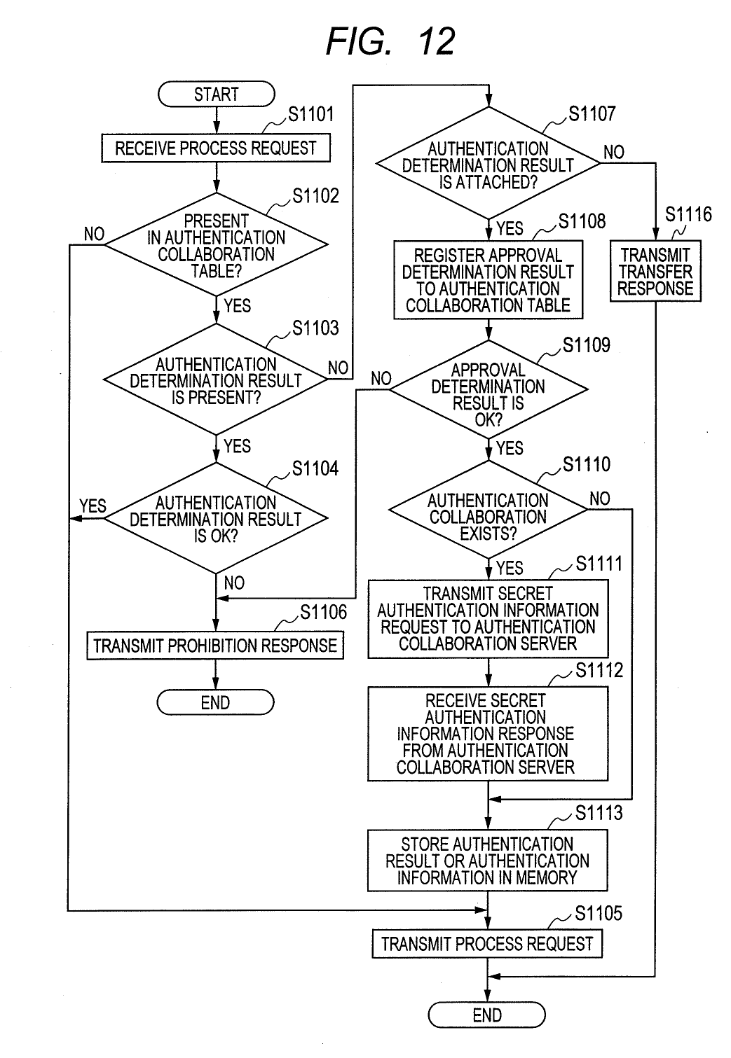

FIG. 12 is a flowchart of the processes performed by the SAML SP unit 61. In FIG. 12, the subject of the whole description is the SAML SP unit 61, so that the SAML SP unit 61 is not spelled out in the description of the individual steps.

As described below, the SAML SP unit 61 performs S1101 to S1107 to determine whether the access control is necessary after the process request is received in S901. If necessary, the SAML SP unit 61 asks for an approval determination result from the authentication collaboration server 2, and performs the access control based on the obtained approval determination result.

In S1101, it receives the process request of S901 from the user terminal 8.

In S1102, it determines whether the record of the combination of the user ID “taro” specified in the process request as well as the URL “http://demosite2.com/sp1/” of the application server 1, is registered in the authentication collaboration table 64 (S1102). If YES in S1102, the process proceeds to S1103. If NO in S1102, the process proceeds to S1105.

In S1103, it determines whether the approval determination result is present in the record searched in S1102. If YES in S1103, the process proceeds to S1004. If NO in S1103, the process proceeds to S1107.

In S1104, it determines whether the approval determination result obtained in S1103 is “OK”. If YES in S1104, the process proceeds to S1104. If NO in S1104, the process proceeds to S1106.

In S1105, it transmits a process request to the application server 1.

In S1106, it transmits a prohibition response indicating authentication failure, to the user terminal 8.

In S1107, it determines whether the approval determination result is attached to the message received from the user terminal 8. If YES in S1107, the process proceeds to S1108. If NO in S1107, the process proceeds to S1116.

In S1108, it registers the approval determination result in the authentication collaboration table 64.

In S1109, it determines whether the approval determination result is “OK (authentication success)”. If YES in S1109, the process proceeds to S1110. If NO in S1109, the process proceeds to S1106.

In S1110, it determines whether the authentication collaboration is “present” or not. If YES in S1110, the process proceeds to S1111. If NO in S1110, the process proceeds to S1113.

In S1111, it transmits the secret authentication information request of S1006 to the authentication collaboration server 2b.

In S1112, it receives the secret authentication information response of S1010 from the authentication collaboration server 2b.

In S1113, it stores the authentication result or authentication information (included in the secret authentication information response). Then, the process proceeds to S1105.

In S1116, it generates the transfer response of S902, and transmits to the user terminal 8.

As described above, in the single sign-on system according to the second embodiment, the single sign-on system of the domain A transmits the authentication information on behalf of the user, to the authentication server 4 in the single sign-on system of the other domain B. Then, the authentication server 4 obtains the authentication information to perform user authentication. In this way, single sign-on across a plurality of systems can be achieved.

On the other hand, the existing single sign-on system can only contribute to authentication collaboration as the sole single sign-on system in the same domain. This is due to technical constraints, physical constraints, or the restrictions imposed by the security policy. In this case, it is possible to reduce the burden on the user caused by the input operation of the authentication information as well as the management of the authentication information, with respect to the service collaborating with the single sign-on system used by the user. However, the user may not receive any benefit from single sign-on with respect to other services. Further, even if the user can use a plurality of single sign-on systems, it is necessary to input the authentication information for each single sign-on system. Thus, there is a problem of managing passwords existed before the application of single sign-on.

Here, ID management technology has been used in conjunction with single sign-on. This technology manages ID and attribution information that the user uses for each service in an integrated manner, and provides the necessary information to the particular service. JP-A No. 113462/2010 discloses a method for securely providing information about the user (user ID and attribute information), including user ID and assertion, only to necessary devices.

However, in JP-A No. 113462/2010, there is not description of the provision of the authentication information, which is the cornerstone of the credibility of the person, from the authentication server 4 to the third party as described in the second embodiment.

What is claimed is:

1. An authentication collaboration system for approving execution of a service provided by an application server to a user terminal used by a user, by requiring results of authentication performed multiple times for the user as a user authentication state, according to the policy for the approval of the service, the authentication collaboration system comprising:
an authentication server for outputting the authentication results constituting the user authentication state by determining that the authentication process is successful when authentication information corresponding to the user is data registered in a storage unit of the own device;
an authentication collaboration server for approving the service when the user authentication state, which is a set of the authentication results output from the authentication server, satisfies the policy specified for each service; and
an authentication information verification server for verifying application in a plurality of pieces of the authentication information, with respect to the particular authentication information used for the authentication process by the authentication server,
wherein the authentication server performs a secret calculation process using, as input, the authentication information used for the authentication process, to generate secret authentication information for each piece of the authentication information,
wherein the authentication information verification server obtains and compares a plurality of sets of the combination of the secret authentication information generated by the authentication server, as well as a user ID uniquely identifying the user of the user terminal using the authentication information that is the source of the secret authentication information, and thereby extracts the plurality of pieces of authentication information that are applied in relation to the particular combination, and
wherein the authentication collaboration server determines whether the user authentication state after the authentication result in which application of the authentication information has occurred is removed as the authentication results constituting the user authentication state, satisfies the policy in the process for approving the service.

2. An authentication collaboration system for approving execution of a service provided by an application server to a user terminal used by a user, by requiring results of authentication performed multiple times for the user, as a user authentication state, according to the policy for the approval of the service, the authentication collaboration system comprising:
an authentication server for outputting the authentication results constituting the user authentication state by determining that the authentication process is successful when authentication information corresponding to the user is data registered in a storage unit of the own device;
an authentication collaboration server for approving the service when the user authentication state, which is a set of the authentication results output from the authentication server, satisfies the policy specified for each service; and
an authentication information verification server for verifying application in a plurality of pieces of the authentication information, with respect to the authentication information used for the authentication process by the authentication server,
wherein the authentication server performs a secret calculation process using, as input, the authentication information used for the authentication process as well as a user ID uniquely identifying the user of the user terminal, to generate secret authentication information for each piece of the authentication information,
wherein the authentication information verification server obtains and compares the plurality of pieces of secret authentication information generated by the authentication server, and thereby extracts the plurality of pieces of authentication information that are applied in relation to the combination of the authentication information, and
wherein the authentication collaboration server determines whether the user authentication state after the authentication result in which application of the authentication information has occurred is removed as the authentication results constituting the user authentication state, satisfies the policy in the process for approving the service.

3. An authentication collaboration system for approving execution of a service provided by an application server to a user terminal used by a user, by requiring results of authentication performed multiple times for the user as a user authentication state, according to the policy for the approval of the service, the authentication collaboration system comprising:
an authentication server for outputting the authentication results constituting the user authentication state by determining that the authentication process is successful when authentication information corresponding to the user is data registered in a storage unit of the own device;
an authentication collaboration server for approving the service when the user authentication state, which is a set of the authentication results output from the authentication server, satisfies the policy specified for each service; and
an authentication information verification server for verifying application in a plurality of pieces of the authentication information, with respect to the authentication information used for the authentication process by the authentication server,
wherein when the same user terminal establishes sessions with a plurality of the authentication servers, the authentication server uses the same session ID for identifying the individual sessions, and then performs a secrecy calculation process using, as input, the authentication information used for the authentication process as well as the session ID, to generate secret authentication information for each piece of the authentication information,
wherein the authentication information verification server obtains and compares the plurality of pieces of secret authentication information generated by the authentication server, and thereby extracts the plurality of pieces of authentication information that are applied with respect to the particular combination, and
wherein the authentication collaboration server determines whether the user authentication state after the authentication result in which application of the authentication information has occurred is removed as the authentication results constituting the user authentication state, satisfies the policy in the process for approving the service.

4. The authentication collaboration system according to claim 1,
wherein when the authentication method of the authentication process to be performed is password authentication or digital certificate authentication, as the secret calculation process, the authentication server generates the secret authentication information by calling a hash value that takes an input value as an argument, and
wherein, as a matching process for extracting the plurality of pieces of authentication information that have been applied, the authentication information verification server determines that the plurality of pieces of authentication information have been applied when the values of the plurality of pieces of secret authentication information match.

5. The authentication collaboration system according to claim 1,
wherein when the authentication method of the authentication process to be performed is biometrics authentication, as the secret calculation process, the authentication server generates the secret authentication information by calling a function that applies an invariant transformation to the correlation of biological information, using, as input, the authentication information of a human body as well as a private key,
wherein, as a matching process for extracting the plurality of pieces of authentication information that have been applied, the authentication information verification server determines that the plurality of pieces of authentication information have been applied when the degree of similarity of the plurality of pieces of authentication information is equal to or greater than a predetermined value.

6. An authentication collaboration method performed by an authentication collaboration system for approving execution of a service provided by an application server to a user terminal used by a user, by requiring results of authentication performed multiple times for the user as a user authentication state, according to the policy for the approval of the service, the authentication collaboration system comprising:
an authentication server for outputting the authentication results constituting the user authentication state by determining that the authentication process is successful when authentication information corresponding to the user is data registered in a storage unit of the own device;
an authentication collaboration server for approving the service when the user authentication state, which is a set of the authentication results output from the authentication server, satisfies the policy specified for each service; and
an authentication information verification server for verifying application in a plurality of pieces of the authentication information, with respect to the particular authentication information used for the authentication process by the authentication server,
wherein the authentication information verification server obtains and compares a plurality of sets of the combination of the secret authentication information generated by the authentication server, as well as a user ID uniquely identifying the user of the user terminal using the authentication information that is the source of the secret authentication information, and thereby extracts the plurality of pieces of authentication information that are applied in relation to the particular combination, and
wherein the authentication collaboration server determines whether the user authentication state after the authentication result in which application of the authentication information has occurred is removed as the authentication results constituting the user authentication state, satisfies the policy in the process for approving the service.

7. An authentication collaboration method performed by an authentication collaboration system for approving execution of a service provided by an application server to a user terminal used by a user, by requiring results of authentication performed multiple times for the user as a user authentication state, according to the policy for the approval of the service, the authentication collaboration system comprising:
an authentication server for outputting the authentication results constituting the user authentication state by determining that the authentication process is successful when authentication information corresponding to the user is data registered in a storage unit of the own device;
an authentication collaboration server for approving the service when the user authentication state, which is a set of the authentication results output from the authentication server, satisfies the policy specified for each service; and
an authentication information verification server for verifying application in a plurality of pieces of the authentication information, with respect to the authentication information used for the authentication process by the authentication server,
wherein the authentication server performs a secret calculation process using, as input, the authentication information used for the authentication process as well as a user ID uniquely identifying the user of the user terminal, to generate secret authentication information for each piece of the authentication information,
wherein the authentication information verification server obtains and compares the plurality of pieces of secret authentication information generated by the authentication server, and thereby extracts the plurality of pieces of authentication information that are applied in relation to the combination of the secret authentication information, and
wherein the authentication collaboration server determines whether the user authentication state after the authentication result in which application of the authentication information has occurred is removed as the authentication results constituting the user authentication state, satisfies the policy in the process for approving the service.

8. An authentication collaboration method performed by an authentication collaboration system for approving execution of a service provided by an application server to a user terminal used by a user, by requiring results of authentication performed multiple times for the user as a user authentication state, according to the policy for the approval of the service, the authentication collaboration system comprising:
an authentication server for outputting the authentication results constituting the user authentication state by determining that the authentication process is successful when authentication information corresponding to the user is data registered in a storage unit of the own device;
an authentication collaboration server for approving the service when the user authentication state, which is a set of the authentication results output from the authentication server, satisfies the policy specified for each service; and
an authentication information verification server for verifying application in a plurality of pieces of the authentication information, with respect to the authentication information used for the authentication process by the authentication server,
wherein when the same user terminal establishes sessions with a plurality of the authentication servers, the authentication server uses the same session ID for identifying the individual sessions, and then performs a secrecy calculation process using, as input, the authentication information used for the authentication process as well as the session ID, to generate secret authentication information for each piece of the authentication information,
wherein the authentication information verification server obtains and compares the plurality of pieces of secret authentication information generated by the authentication server, and thereby extracts the plurality of pieces of authentication information that are applied with respect to the combination of the secret authentication information, and
wherein the authentication collaboration server determines whether the user authentication state after the authentication result in which application of the authentication information has occurred is removed as the authentication results constituting the user authentication state, satisfies the policy in the process for approving the service.

9. The authentication collaboration method according to claim 6,
wherein when the authentication method of the authentication process to be performed is password authentication or digital certificate authentication, as the secrecy calculation process, the authentication server generates the secret authentication information by calling a hash value that takes an input value as an argument, and
wherein, as a matching process for extracting the plurality of pieces of authentication information that have been applied, the authentication information verification server determines that the plurality of pieces of authentication information have been applied when the values of the plurality of pieces of secret authentication information match.

10. The authentication collaboration method according to claim 6,
wherein when the authentication method of the authentication process to be performed is biometrics authentication, as the secrecy calculation process, the authentication server generates the secret authentication information by calling a function that applies an invariant transformation to the correlation of biological information, using, as input, the authentication information of a human body as well as a private key,
wherein, as a matching process for extracting the plurality of pieces of authentication information that have been applied, the authentication information verification server determines that the plurality of pieces of authentication information have been applied when the degree of similarity of the plurality of pieces of authentication information is equal to or greater than a predetermined value.
